(19) United States
(12) Patent Application Publication
(10) Pub. No.: US 2014/0324749 A1
(43) Pub. Date: Oct. 30, 2014

(54) EMOTIONAL INTELLIGENCE ENGINE FOR SYSTEMS

(71) Applicants: Alexander Peters, St. Catherines (CA); Rohan Mahimker, Mississauga (CA); Steve Bergen, St. Catherines (CA)

(72) Inventors: Alexander Peters, St. Catherines (CA); Rohan Mahimker, Mississauga (CA); Steve Bergen, St. Catherines (CA)

(21) Appl. No.: 13/848,537

(22) Filed: Mar. 21, 2013

Related U.S. Application Data
(60) Provisional application No. 61/613,667, filed on Mar. 21, 2012.

(51) Int. Cl. G06N 5/02

(52) U.S. Cl. CPC G06N 5/02
USPC 706/46

(57) ABSTRACT

There is disclosed a system and method for adapting digital content to a user's emotional state. In an embodiment, the system comprises: one or more sensors for capturing physiological data to monitor the emotional response of a user to stimulus in their environment; an emotional intelligence engine for determining the emotional state of the user based on physiological data filtered and processed from the one or more sensors; means for correlating the determined emotional state of the user with one or more user performance metrics relating to the user's interaction with digital content; and means for adapting the digital content in response to the user's emotional state and one or more user performance metrics to achieve a desired emotional state for the user.

### CROSS REFERENCE TO RELATED APPLICATIONS

This application claims all benefit, including priority, of each of U.S. Provisional Patent Application Ser. No. 61/613,667, filed Mar. 21, 2012, entitled EMOTIONAL INTELLIGENCE ENGINE FOR SYSTEMS, the entire contents of which is incorporated herein by this reference.

### FIELD OF THE INVENTION

This present disclosure relates generally to an emotional intelligence engine capable of adapting an interactive digital media program to a user's emotional state.

### BACKGROUND

In human to human interaction, inferred information about the other person's emotional state is commonly factored into the decision making process. For example, imagine a human teacher who is teaching a child a complex algebra problem. During the teaching session, the teacher is able to infer the student's emotional state through the student's facial expressions, tonality, movement, and other psychophysiological responses. If the teacher observes that the student is frustrated, the teacher would likely react to this information by speaking more slowly, reviewing easier algebra concepts, or taking another action to mitigate the student's frustration.

There are three critical issues to building an interactive digital media system that reacts to a user's emotions in a similar manner:
1. The definition and characteristics of certain emotions such as ‘frustration’ are ambiguous, even in the psychological community.
2. Different classification methods are required for each physiological measurement. For example, classifying ‘frustration’ through Galvanic Skin Response measured at the fingertips, versus through facial recognition software with images from a computer-mounted camera would require a completely different set of criteria, tests, and data.
3. Given an emotional state (e.g. frustration), the system would require prior knowledge from an expert in the field to determine an appropriate action.

Certain examples of interactive systems involving emotion recognition methods or devices are known. For example, US Publication No. 2008/0001951A1 (U.S. application Ser. No. 11/801,036) relates to a system for providing affective characteristics to computer generated avatar during game-play, where an avatar in a video game designed to represent real-world players is modified based on the real-world player's reactions to game-play events. Another example is U.S. Pat. No. 7,547,279 B2 which relates to a system and method for recognizing a user's emotional state using short-time monitoring of one or more of a user's physiological signals (US). Another example is US Publication No. 2008/0214903 A1 (U.S. application Ser. No. 11/917,767) which relates to methods and system for physiological and psycho-physiological monitoring and uses thereof. The specification describes a portable, wearable sensor to monitor a user's emotional and physiological responses to events in real-time. Data is gathered so that it can be displayed on a mobile device, coaching can be provided, and users can modify negative behaviours. Another example is U.S. Pat. No. 5,987,415 which relates to modeling a user's emotion and personality in a computer user interface. Another example is a study on using biometric sensors for monitoring user emotions in educational games. The study assesses the performance of students using biometric signals including skin conductance (SC), electromyography (EMG), blood volume pulse (BVP), and respiration (RESP).

While the above illustrative examples attempt to adapt a system in response to various user inputs and physiological measurements, prior systems may not be particularly effective for achieving a desired outcome or change in the emotional state of the user.

### SUMMARY

This present disclosure relates generally to a system, method and an emotional intelligence engine capable of adapting digital content (such as interactive educational content or gaming content) to a user's emotional state. More particularly, in one aspect, there is disclosed a system and method for adapting digital content to achieve a desired outcome in the digital content, a desired emotional response, or a combination of both, in the fields of education and gaming. In an embodiment, the system and method provides a content filter capable of adapting to a user's emotional state, both emotional and digital content-related, by correlating a user's emotional state with changes in the digital content state, in order to promote a desired learning experience.

In another embodiment, the system and method allows interactive digital content to adapt to achieve a desired emotional state in their users, in order to create a desired user experience.

In another embodiment, the system and method allows interactive digital content to predict user-driven changes in the digital content, identify a user's current emotional response, and predict a user's emotional response to any change in the digital content, in order to intelligently adapt the content to achieve a desired user experience, consisting of preferred outcomes in the digital content, a desired emotional response, or a combination of both.

In another embodiment, the system and methods include an Emotional Intelligence Engine (EIE) implemented as a library with an associated Application Programming Interface (API) that is included in a Digital Content System, in order to promote a customized outcome or user experience. This allows third party software to adapt content in response to a user's emotions based on feedback from the API.

In another embodiment, the system and method is a cloud implementation of an emotional intelligence engine that evaluates a user's individual preferences in order to promote a customized user experience. This allows third party software to adapt content in response to a user's emotions based on feedback from a cloud.

In another embodiment, the system and method includes an EIE implemented as a library with an associated API that is included in a Digital Content System in order to promote a desired outcome or user experience. The Digital Content System interacts with a cloud-based EIE Training System in order to discover an optimal EIE configuration based on data from one or more users. This allows third party software to adapt content in response to a user's emotions based on feedback from the API, while allowing the flexibility to leverage data from multiple users in a distributed manner.

In one aspect, there is provided a method for combining the Psychophysiological Data (PD) from any psychophysiological sensor with the state of a Digital Content (DC) system to predict the DC's future state, comprising: (a) capturing physiological data using one or more sensors to monitor the psychophysiological response of a User to the Digital Content's state; (b) filtering and processing the PD into time-steps to reduce noise and allow for more effective pattern recognition; (c) combining the filtered PD with time-stamped Digital Content states to identify correlations between changes in the DC state and the user's PD; and (d) determining the likely outcome of future DC states based on these correlations.

In another aspect, there is provided a method for the automated classification of a user's emotional response based on physiological data, comprising: (a) capturing physiological data using one or more sensors to monitor the psychophysiological response of a User to the Digital Content's state; (b) filtering and processing the PD into time-steps to reduce noise and allow for more effective pattern recognition; (c) combining the filtered PD with Digital Content states which have been classified as representing an emotional response to identify correlations between the user's PD and these Known Value States; and (d) determining the emotional response classification of new signals based on these correlations.

In yet another aspect, there is provided a method for predicting the impact of digital content on a user's emotional state, comprising: (a) capturing physiological data using one or more sensors to monitor the psychophysiological response of a User to the Digital Content's state; (b) filtering and processing the PD into time-steps to reduce noise and allow for more effective pattern recognition; (c) combining the PD with each change in the digital content's state independently to identify correlations between specific changes in the digital content state and the user's physiological data; and (d) predicting the user's physiological signal for each digital content state change to allow the reliable prediction of how digital content can be altered to achieve the desired emotional response from the user.

In one aspect, characteristics of the physiological sensors are known by the emotional response system, and filtering of the data captured by these sensors is specific to the type of sensors used and the characteristics of that sensor.

In another aspect, new or unknown physiological sensors can be added to the emotional response system, and generic filtering techniques will be applied.

In accordance with an aspect of the present invention, there is provided a method, performed by a computing device in communication with at least one sensor, comprising: receiving physiological data from the at least one sensor, the physiological data representative of a user emotional response measured by the at least one sensor; correlating the received physiological data with program state data, each of the received physiological data and the program state data associated with a predetermined time interval; determining an emotional response type corresponding to the received physiological data by comparing the received physiological data with at least one physiological data profile associated with a predetermined emotional response type; and providing an indication associated with modified program state data, the modified program state data based at least partly on the program state data and the determined emotional response type.

In accordance with another aspect of the present invention, there is provided a method, performed by a computing device in communication with at least one sensor and a computer server, comprising: the computing device receiving physiological data from the at least one sensor, the physiological data representative of a user emotional response measured by the at least one sensor; the computing device transmitting the received physiological data and program state data to the computer server; the computer server correlating the received physiological data with the program state data, each of the received physiological data and the program state data associated with a predetermined time interval; the computer server determining an emotional response type corresponding to the received physiological data by comparing the received physiological data with at least one physiological data profile associated with a predetermined emotional response type; the computer server transmitting modified program state data to the computing device, the modified program state data based at least partly on the program state data and the determined emotional response type; and the computing device providing an indication associated with modified program state data.

In accordance with another aspect of the present invention, there is provided a method, performed by a computing device in communication with at least one sensor and a computer server, comprising: the computing device receiving physiological data from the at least one sensor, the physiological data representative of a user emotional response measured by the at least one sensor; the computing device correlating the received physiological data with the program state data, each of the received physiological data and the program state data associated with a predetermined time interval; the computing device updating at least one physiological data profile associated with a predetermined emotional response type with updated physiological data received from the computer server; the computing device determining an emotional response type corresponding to the received physiological data by comparing the received physiological data with the received at least one physiological data profile; and the computing device providing an indication associated with modified program state data, the modified program state data based at least partly on the program state data and the determined emotional response type.

In accordance with another aspect of the present invention, there is provided a computer system for adapting digital content comprising: (a) one or more computers, implementing a content adapting utility, the content adapting utility when executed: receives physiological data from at least one sensor, the physiological data representative of a user emotional response measured by the at least one sensor; correlates the received physiological data with program state data, each of the received physiological data and the program state data associated with a predetermined time interval; determines an emotional response type corresponding to the received physiological data by comparing the received physiological data with at least one physiological data profile associated with a predetermined emotional response type; and provides an indication associated with modified program state data, the modified program state data based at least partly on the program state data and the determined emotional response type.

In accordance with another aspect of the present invention, there is provided a computer system for adapting digital content comprising: (a) one or more computers, including or linked to a device for communication content (“content device”) to one or more users, and implementing a content adapting utility for adapting content generated by one or more computer programs associated with the one or more computers, wherein the one or more computer programs include a plurality of rules for communicating content to one or more users using the content device, wherein the content adapting utility when executed: receives physiological data from at least one sensor, the physiological data representative of a user emotional response measured by the at least one sensor; correlates the received physiological data with program state data, each of the received physiological data and the program state data associated with a predetermined time interval; determines an emotional response type corresponding to the received physiological data by comparing the received physiological data with one or more parameters associated with a predetermined emotional response type, including one or more of the rules for communication content; and adapting digital content displayed to the one or more users based on user emotion response by executing the one or more rules for displaying content that correspond to the relevant emotional response type.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 shows a high level description of the various components of the system and method in accordance with an illustrative embodiment.

FIG. 2 shows sample State Variables that comprise a Digital Content State for an interactive math program.

FIG. 3 shows an illustrative architecture of the Sensor(s) and Filter(s) of the system and method.

FIG. 3a tabulates sample GSR values and the relative difference between subsequent readings.

FIG. 4 shows an illustrative architecture of the Digital Content State Prediction System in accordance with an illustrative embodiment.

FIG. 5 shows a sample implementation of a DCSPS that is being used in an educational gaming application using an Artificial Neural Net as a Pattern Recognition System, a GSR sensor as the PD input, and predicting whether or not the user will answer the current question correctly, in accordance with an embodiment.

FIG. 5a shows a sample chart of a PD series and its use in training a DCSPS with a subsection of the series, the training set, highlighted.

FIG. 5b shows a sample chart of a PD series and its use in training a DCSPS with an alternate training set highlighted.

FIG. 6 tabulates various Known Values States based on the Digital Content System type.

FIG. 7 shows an illustrative architecture of the Generic Emotional Response Classification System.

FIG. 8 illustrates the Known Value States (KVS) concept for three common KVS that appear in the video games.

FIG. 9 tabulates an illustrative example of the data used to train a GERCS implementation.

FIG. 10 shows a sample chart of three PD series in response to the introduction of a Reward.

FIG. 11 tabulates an illustrative example of three data series obtained for the Reward KVS.

FIG. 12 shows a sample chart of three PD series in response to the introduction of a Reward for three different Users.

FIG. 13 shows a sample chart of three PD series in response to the introduction of a Reward for three different Users, that has been transformed using Bollinger Bands to identify generic patterns.

FIG. 14 tabulates an illustrative example of three PD series that have been transformed using the Bollinger Bands method.

FIG. 15 shows an illustrative architecture of the Emotional Response Classification System.

FIG. 16 shows a sample chart of three separate DC State variables: Question Correct, Character Died, and Reward Offered.

FIG. 17 shows a sample chart of three instances of the Question Correct state change and the corresponding impact on the user's PD.

FIG. 18 shows an illustrative architecture of an EIE consisting of a DCSPS and DS in accordance with an illustrative embodiment.

FIG. 19 shows an example embodiment of the EIE where the DCS is an education game and the system's Goal is to maintain a Correct Response rate of 75% for the user by incorporating values from a GSR sensor.

FIG. 20 tabulates sample inputs for an embodiment of the EIE where the DCS is an education game and the ERS is comprised of the DCSPS.

FIG. 21 tabulates sample outputs for an embodiment of the EIE where the DCS is an education game and the ERS is comprised of the DCSPS.

FIG. 22 shows an illustrative embodiment highlighting the flow of information in the EIE where the DCS is an education game and the ERS is comprised of the DCSPS.

FIG. 23 shows an illustrative architecture of an emotional intelligence engine in accordance with an embodiment.

FIG. 24 tabulates sample inputs for an embodiment of the EIE where the DCS is an education game for students with Autism and incorporates the DCSPS and GERCS to create a more complex Goal to modify the DCS.

FIG. 25 tabulates sample outputs for an embodiment of the EIE where the DCS is an education game for students with Autism and incorporates the DCSPS and GERCS to create a more complex Goal to modify the DCS.

FIG. 26 shows an illustrative embodiment highlighting the flow of information in the EIE where the DCS is an education game for students with Autism and the ERS is comprised of a DCSPS and GERCS.

FIG. 27 shows an illustrative architecture of an EIE where the ERS is comprised of a DCSPS, GERCS, and ERPS, and a DS, in accordance with an embodiment.

FIG. 28 tabulates sample outputs for an embodiment of the EIE where the DCS is an education game for students with Autism and incorporates the DCSPS, GERCS, and ERPS to create a more complex Goal to modify the DCS.

FIG. 29 shows an illustrative embodiment highlighting the flow of information in the EIE where the DCS is an education game for students with Autism and the ERS is comprised of a DCSPS, GERCS, and ERPS.

FIG. 30 shows an illustrative example of an embodiment of the system and method where the EIE is included as a local library in the Digital Content System.

FIG. 31 shows an illustrative example of an embodiment of the system and method where the EIE included in a cloud implementation.

FIG. 32 shows an illustrative example of an embodiment of the system and method where the EIE is included as a local library in the Digital Content System and there is a cloud-based EIE Training System.

FIG. 33 illustrates a representative generic implementation of the invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

As noted above, the present disclosure relates generally to a system, method and an emotional intelligence engine capable of adapting digital content (such as interactive educational content or gaming content) to a user's emotional state. More particularly, in one aspect, there is disclosed a system and method for adapting digital content to achieve a desired outcome in the digital content, a desired emotional response, or a combination of both, in the fields of education and gaming. Any implementations of the emotional intelligence engine described herein may be implemented in computer hardware or as computer programming instructions configuring a computing device to perform the functionality of the emotional intelligence engine as described.

In this document, a Digital Content System (DCS) is defined broadly as an interactive digital system that influences a user's experience. The Digital Content System may maintain at least one digital content state (dc state) based on user feedback and other inputs. The dc state may also be referred to as the program state. Program state data, or state data, may be representative of the program state. Psychophysiological sensors refers to physiological sensors which respond to changes in a user's emotional arousal or valence. Samples include, but are not limited to: Galvanic Skin Response (GSR) sensors, Heart Rate (HR) sensors, Facial Recognition (FR) software, and Electroencephalography (EEG).

There may be several applications of the present invention. In particular, education is a highly competitive field in which teachers and school boards are expected to accommodate each child's individual needs. This is seen in numerous school boards across Canada and the United States. For example, the Government of Ontario states its belief that “universal design and differentiated instruction are effective and interconnected means of meeting the learning or productivity needs of any group of student . . . ”. With a wide range of abilities present in each and every class, teachers must spend increasing amounts of time trying to create different content for individual students before evaluating their progress towards provincial proficiency standards.

In general, educators must deal with some or all of the following issues: (1) A highly competitive education environment for students in which grades have an enormous impact on post-secondary education options and future job prospects; (2) A lot of repetitive content, where teachers are forced to create and grade new tests for skills that have been taught for decades; (3) Each child learns differently, and students enter a school year with a wide range of academic ability and different learning styles. For example, the Province of Ontario lists requirements for differentiated instruction as: different modes of perception (learning principle); differentiated content; differentiated process; and differentiated product. Another issue with current educational products is that they do not actively prevent the child from becoming overly frustrated. This is a serious problem that can have long-lasting implications as frustration can reduce a child's belief in their own abilities and cause children to develop negative feelings towards the educational stimulus itself. It may also lead to lack of engagement and a growing number of distractions at home.

In a related field of gaming, the video game industry is still relatively new and is growing in market size. As video game developers get more competitive, the technology used in video games continues to advance to make games more realistic, interactive, and adaptive. Traditional video games take in a user's input through a hardware device, such as a controller or a keyboard, and generate visual feedback of the user's interaction on a video device. Increases in computer speed and technology have made it possible for video games to incorporate additional user inputs such as an image from a camera or motion from a wrist band. This enables greater interactivity and allows the video game to more intelligently respond to a user's actions or inputs. As additional inputs become available, new methods of user feedback can be incorporated. Some examples of this would be to modify game play mechanics and alter content for the video device, audio device, or a haptic feedback device. Examples of video game platforms are personal computers, handheld mobile devices such as iPhones and PSPs, portable devices such as iPads, and consoles such as the Sony Playstation and Nintendo Wii. More recently, online portals or services such as Facebook have also become a “platform” on which video games exist. Each of these platforms offers slightly different forms of interactivity with the video game.

As interactive technology continues to develop and improve, it is becoming technically possible to add another dimension of interactivity. The inventors have recognized that various improvements may be made in capturing a user's emotional state as an input to an educational or gaming program. This provides the possibility of using emotional data of users as part of the feedback to adapt the educational or gaming program to elicit a desired user experience or outcome. For example, emotional feedback can be used to decide what action to take based on an overall goal. Once emotional response signals are classified, the goal of the system (e.g. to keep the user in a happy or engaged state) is defined and used to adapt or calibrate the educational or gaming program in various ways.

Some use case examples of implementations of the present invention are described under the non-limiting exemplary use case headings found later in this document.

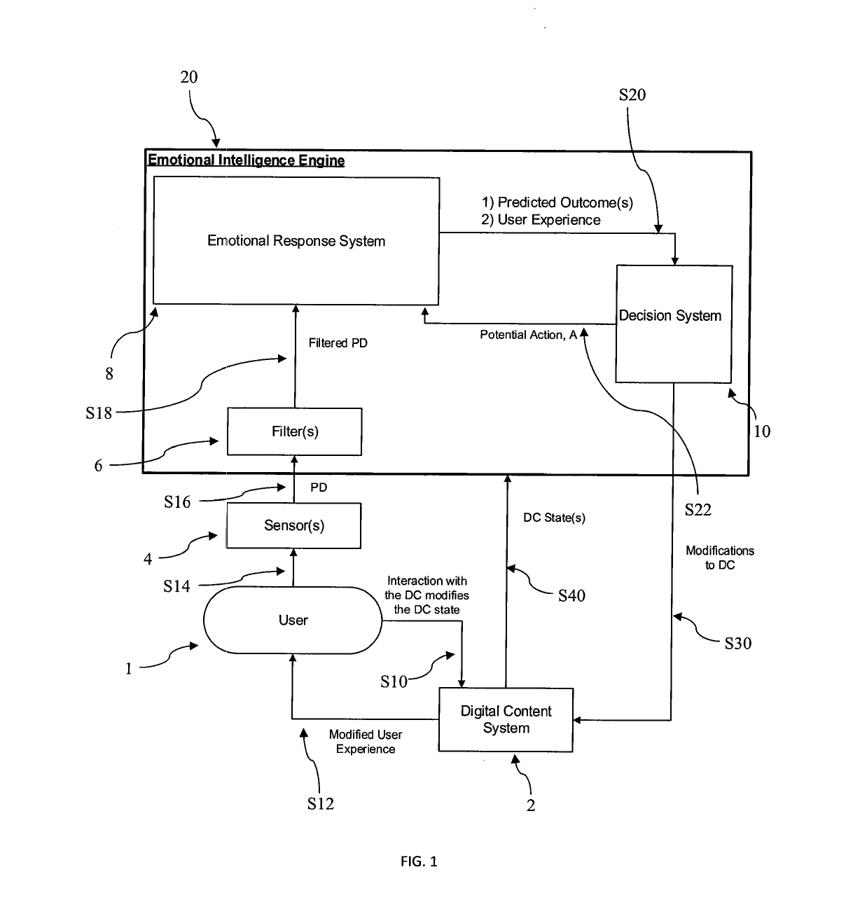

Now referring to FIG. 1, shown is a high-level description of various components of the system and method in accordance with an illustrative embodiment. As shown, as a first step S10, a user 1 interacts with a Digital Content System 2. In response, the Digital Content System 2 influences or modifies the user 1's experience at S12. The user 1's interaction with the Digital Content System 2 may change the current Digital Content state, as detailed further under the heading “Digital Content System” below. The digital content system may be implemented on a single computing device, such as a desktop computer, handheld, or other mobile device, or on a plurality of linked devices.

Still referring to FIG. 1, one or more sensors 4 may be used to monitor a user's emotional response (i.e. psychophysiological response) at step S14 to stimulus in their environment, including interaction with the Digital Content System 2. Sensor(s) 4 may include sensors which would monitor a user's physiological data which are physically attached to the user (e.g. such as a wrist band monitoring Galvanic Skin Response (GSR) from the user's skin), or unattached to the user (such as webcam in combination with a facial recognition software). The sensor(s) 4 may transmit physiological data to an Emotional Intelligence Engine (EIE) 20 at step S16. The EIE 20 may reside in the digital content system 2 or all or part of the EIE 20 may reside in a separate computing device such as computer server, or in a plurality of computer servers. Accordingly, the sensor(s) 4 may be in communication with the digital content system 2, which may forward any measured data received from the sensor(s) 4 to the EIE 20, or the EIE 20 may receive data directly from the sensor(s) 4 not passed through the digital content system 2.

Still referring to FIG. 1, the EIE 20 includes at least one filter 6 to pre-processes the physiological data from the sensors. The filters 6 may apply a variety of methods to reduce noise due to external factors, and may also remove user-specific biases. For example, a user's GSR data can be heavily influenced by external factors such as temperature or humidity. In addition, there can be large variations in skin resistances from one person to another depending on factors such as skin moisture and thickness.

Still referring to FIG. 1, the EIE 20 may also include Emotional Response System 8 and Decision System 10. The filtered physiological data is sent to the Emotional Response System 8 at step S18, which classifies the filtered physiological data. The Emotional Response System 8 and Decision System 10 together evaluate potential modifications to the digital content at steps S20 to S22, based on the current digital content state(s), the filtered physiological data, and a desired user experience or outcome as defined by a Goal. The Decision System 10 may then determine which digital content modifications are most likely to achieve the desired user experience or outcome, and sends a corresponding command to the Digital Content System 2 at step S30. For example, consider a video-game implementation where a user's virtual avatar is engaged in a battle with a computer opponent, and the user is losing the battle (i.e. current digital content state variable “Winning” is “False”). Given a desired user experience of ‘minimize frustration’ and a current classification of the physiological data as ‘frustrated’, the Decision System may decide to play calming music and temporarily make the user's avatar more powerful.

Still referring to FIG. 1, any modifications made to the digital content in the Digital Content System 2 changes the user experience. In turn, the user's interactions with the Digital Content System 2 alter its digital content state(s). The user 1's interaction with the Digital Content System 2 also influences the user's psychophysiological response, which is captured by the sensor(s) 4. The Digital Content state of the Digital Content System 2 may be communicated to the Emotional Intelligence Engine at step S40 continuously, periodically, whenever a change in the Digital Content state occurs, or based on any other predefined conditions. The digital content state may be communicated by communicating program state data generated or processed by the digital content system 2 to the EIE 20. The program state data may be representative of the state of the digital content system 2 after prompting a user for user input, after having received user input, after providing an indication of some audio or video to the user, or of any other state. The program state data may also include a at least one time code associated with a time where the program state data was active at the digital content system 2 or when the program state data was communicated to the EIE 20. The time codes may be used by the EIE 20 to correlate corresponding physiological data received from the sensor(s) 4. Accordingly, the sensor(s) 4 may include at least one respective time code with the physiological data communicated to the EIE 20 or to the digital content system 2. By matching time codes, or time intervals (where a time interval may be one point in time represented by one time code, or a range of points in time represented by a plurality of time codes) between the physiological data and the program state data, the EIE 20 may determine the physiological data that was measured from the user corresponding to a particular digital content state.

In an non-limiting example of an implementation of the present invention, consider the case of a child (i.e. the user 1) playing with an interactive online Role Playing Game (RPG) (i.e. the Digital Content System 2), where the child is engaged in a battle with a computer opponent, and the child must answer a question correctly to successfully attack their opponent. If the child answers the question incorrectly, the Avatar's attack would be unsuccessful, and in turn, this may result in the child becoming ‘frustrated’. Here, the Digital Content System 2 is the interactive online game, the user 1 is the child, and a digital content state may be a collection of variables that describe that the child's avatar is in a battle (e.g. InBattle=“true”, Winning=“true”, Opponent=“dragon”).

The Digital Content System 2 may be defined broadly as an interactive digital system that influences a user 1's experience, and alters the Digital Content System 2's digital content state(s) based on user feedback and other inputs.

A digital content state, or program state, may include a set of one or more State Variables (e.g. Is a question currently displayed on the screen?) that form a representation of the status of the digital content at a given time. A digital content state or program state may provide an explanation of the digital environment that can be used to facilitate decision making that best achieves the desired user outcome or experience. State Variables are variables that describe a specific element of the digital content. The program state data may include at least one state variable.

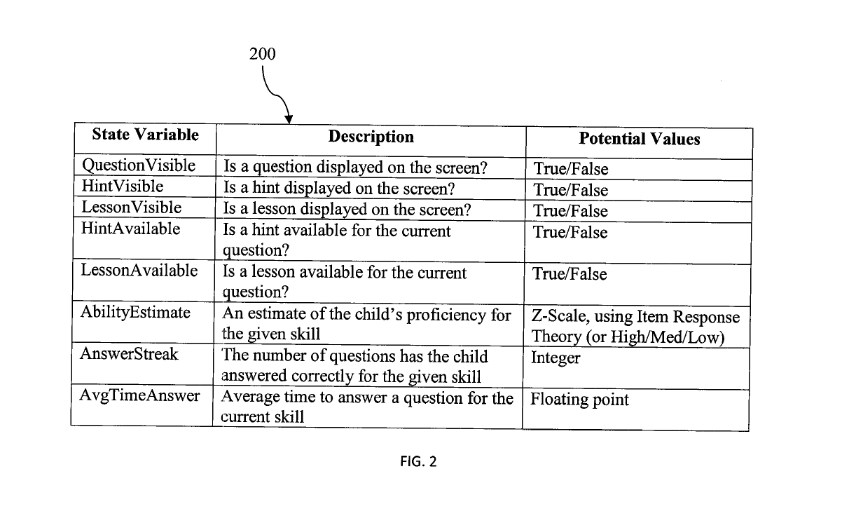

Now referring to FIG. 2, a table 200 is shown which may be implemented within the EIE 20. Table 200 may include at least one state variable each corresponding to a respective state variable description and a potential value. As an example, a child may be interacting with an educational program which asks the child a series of math questions. If the EIE 20 determines that a hint and lesson are currently not being displayed, and that the child will likely answer the current question incorrectly, it may tell the educational program to offer a Hint or Lesson (i.e. change the value of HintVisible or LessonVisible).

In one embodiment the Digital Content System 2 is a video-game, where the EIE utilizes information from physiological sensors to modify game events and mechanics to promote a desired user experience.

In another embodiment, the Digital Content System 2 is an interactive educational software, where the EIE 20 utilizes information from physiological sensors to promote a desired learning outcome or user experience.

One limitation of known interactive systems described in the “Background” section is that they are dependent on a classification of the physiological data into a specific emotional category or state. If instead, the physiological data were classified based on its effectiveness towards achieving a desired outcome or user experience, the system could be directly trained to achieve this. There are two main advantages to a system which does not need to classify a user's specific emotional state. Firstly, the system does not need prior information on the characteristics of the specific physiological sensor or measurement method. For example, in the scenario that an unknown physiological sensor was monitoring a child writing an algebra test, the system would be able to classify patterns in the data based on their relation to a desired event or outcome (e.g. answering a question correctly). As the size of the data set increased, the system would become increasingly accurate and less sensitive to noise. Secondly, multiple physiological sensors or measurement methods could be combined to reduce noise in the overall system due to one individual sensor or measurement method.

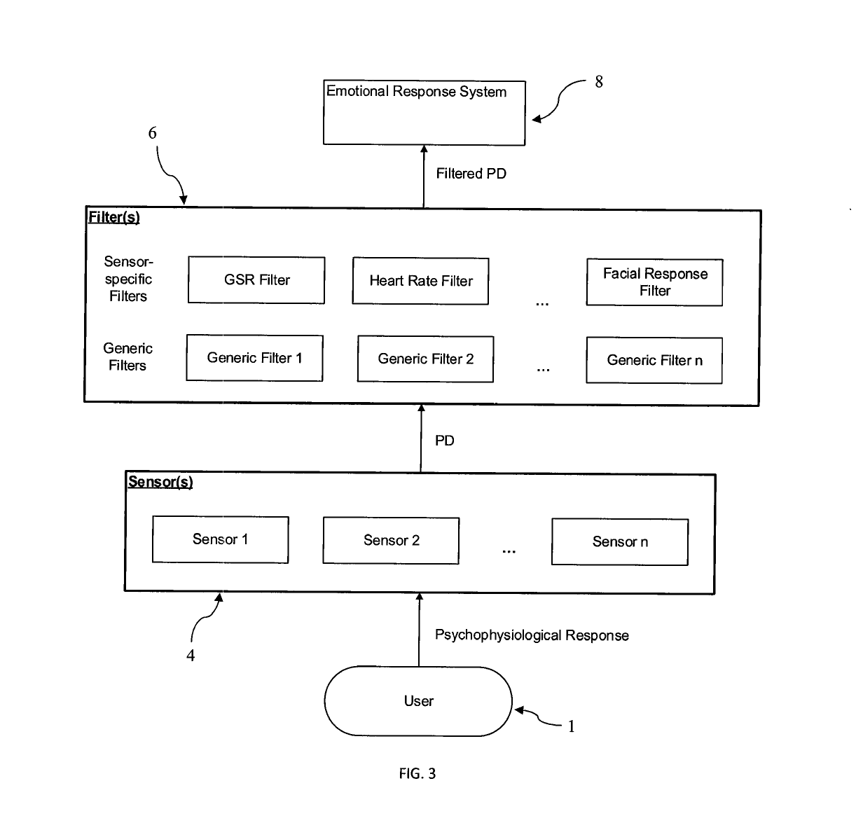

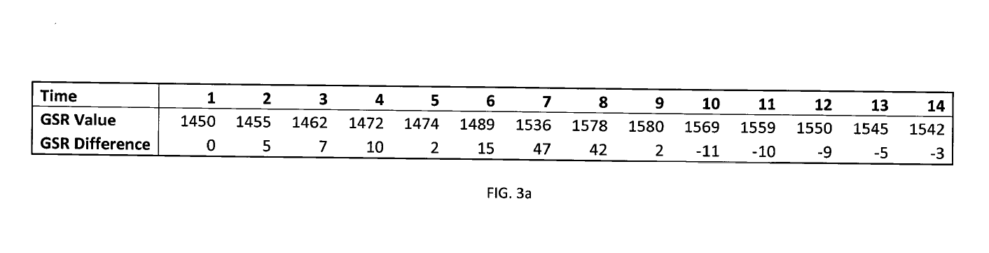

Now referring to FIG. 3, in one aspect, the system and method can incorporate one or more sensors 4 to monitor a user 1's emotional response (i.e. psychophysiological response) to stimulus in their environment, including interaction with the Digital Content System 2. These could include sensors 4 which would monitor a user's physiological data which are physically attached to the user (e.g. such as a wrist band monitoring Galvanic Skin Response (GSR) from the user's skin), or unattached to the user (such as webcam in combination with a facial recognition software). The sensor(s) 4 may be linked to one another or directly linked to the EIE 20.

Still referring to FIG. 3, in another aspect, the system and method can utilize sensor filtering if there are inconsistencies in the data collected by the different sensors 4. Depending on the sensory technology used, data from the sensor(s) 4 could contain noise and/or bad data. Data could also be influenced by environmental factors such as room temperature and humidity. In addition to environmental factors, the user's physical and psychological conditions may change day-to-day depending on activity level and emotional state (e.g. if something traumatic has occurred earlier in the day, they may be more prone to being stressed). Furthermore, there may be differences in the same measurement data between individuals.

Thus, the present system and method is designed to neutralize these factors and reduce noise in the data by the filter(s) 6 applying various techniques, including statistical techniques. As an example, the system and method can take a simple average of the data for a timed period (e.g. every 5 seconds) to lower the granularity and reduce noise. Then a statistical filtering technique may be applied to reduce the dependency on the user's physical and physiological conditions and the differences between users. A scaling method may then be applied to scale the value to a decimal value between 0 and 1, which more easily processed by the Emotional Response System 8. One example of a statistical technique is to apply a simple moving average calculation to the data, to compare the current data point with the previous X data points (e.g. if the current point is higher than 80% of the previous 20 data points, the measure is increasing).

The sensor filtering performed by the present system and method provides an improved approach because each sensor 4 would have slightly different data characteristics (e.g. facial recognition is very prone to noise). By testing and knowing the characteristics of various sensory technologies (heart-rate, facial recognition, galvanic skin response), it is possible to better interpret the data collected from all of the different sensors. Thus, the filtering techniques of the present system and method eliminate not only noise, but also environmental factors, physical & psychological factors, and differences between individuals. Filtering techniques are then developed by the present system and method which could also apply to new sensory technologies which are added to the system. This would allow a multitude of sensors to be used in parallel, and the data derived would be synergistically used by the Emotional Response System 8.

Referring again to FIG. 3, in one aspect, sensor-specific filters 6 can be applied where the characteristics of a sensor are known.

Referring now to FIG. 3a, one example of a sensor-specific filter would be a statistical filter to compute the increase or decrease in GSR values in a given time interval, because it is known that the absolute value of a user's galvanic skin response is not useful to the Emotional Response System 8. In the figure, the GSR Difference at time 2 is as the relative increase or decrease in value compared to time 1.

Referring again to FIG. 3, in another aspect, generic sensor filters can be applied where the characteristics of a sensor are unknown. One example of a generic filter is to apply a simple moving average calculation to each data point to average it with the previous X data points (i.e. Value(t)=Average(Data(t), Data (t−1) . . . Data(t−X))) to reduce the impact of fluctuations or noise in the data. Simple moving averages are commonly used in the financial markets to reduce noise from daily market fluctuations and evaluate the overall price trend of a financial instrument.

One of the Emotional Response System 8 and Decision System 10 may include a Digital Content State Prediction System (DCSPS) 22, Generic Emotional Response Classification System (GERCS) 24, and Emotional Response Prediction System (ERPS) 26 each of which being described in greater detail below.

### Digital Content State Prediction System (DCSPS)

While previous systems have been created that attempt to incorporate the user's emotional state into the decision making process of specific software applications, these systems were limited to known physiological sensors and prior art that identified specific emotional states for the researcher's study group. Since psychophysiological data can be extremely difficult to classify and varies based on external factors like room temperature, the inventors of the present invention recognized that a system which could create a desired user experience based on a User's psychophysiological data without the use of an emotion classification system would be extremely valuable for a generic Digital Content System 2.

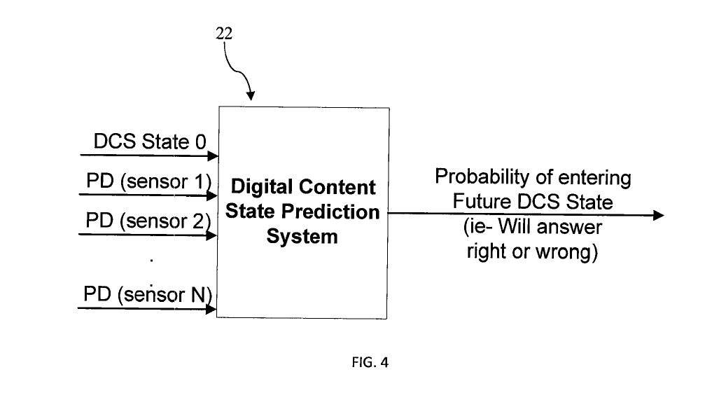

To accomplish this goal, the inventors of the present invention devised a method for combining the Psychophysiological Data (PD) from any psychophysiological sensor with the state of a Digital Content System to predict the DCS's future state, comprising: (a) capturing physiological data using one or more sensors to monitor the psychophysiological response of a User to the Digital Content's state; (b) filtering and processing the PD to reduce noise and allow for more effective pattern recognition; (c) combining the filtered PD with digital content states to identify correlations between changes in the digital content state and the user's PD; and (d) determining the likely outcome of future digital content states based on these correlations. This system is referred to as a Digital Content State Prediction System (DCSPS) 22 throughout the rest of the document. Referring to FIG. 4, an exemplary non-limiting embodiment of the DCSPS 22 is shown. The DCSPS 22 may be implemented as part of the Emotional Response System 8, the Decision 10, or as a separate system within the EIE 20.

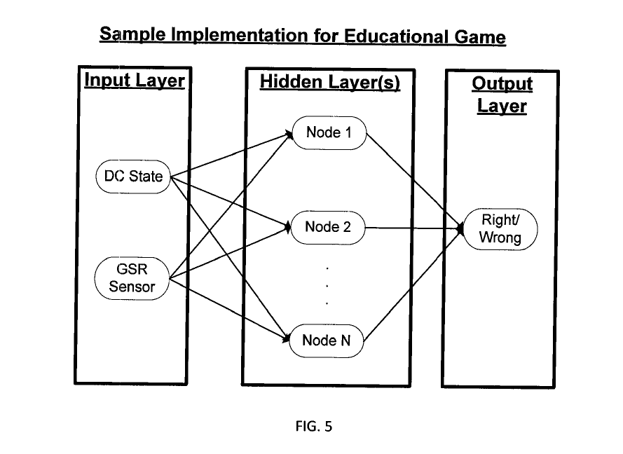

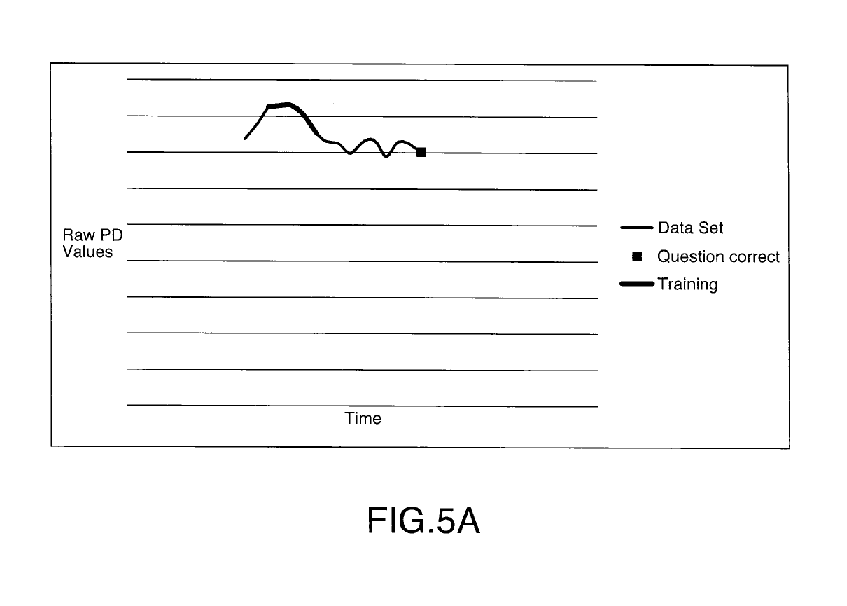

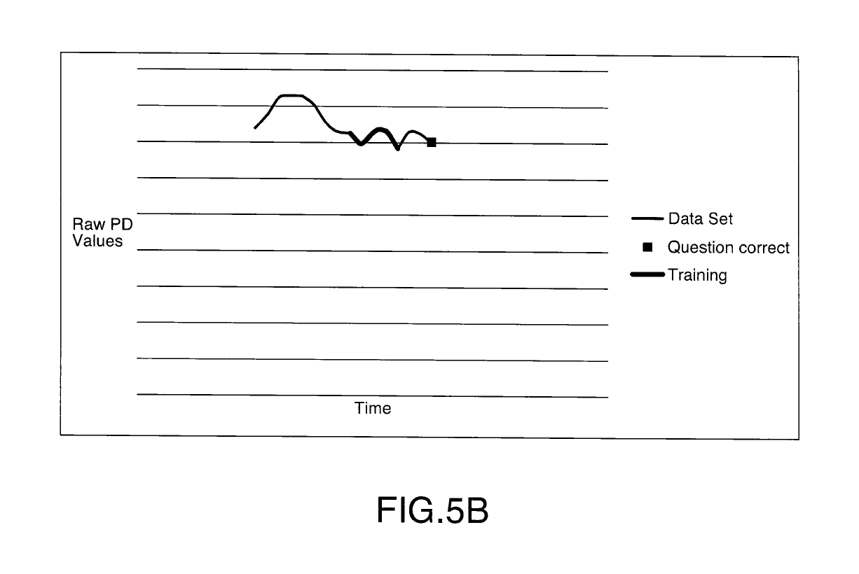

The digital content system state data, or program state data, is combined with the filtered and processed data from any available psychophysiological sensors and trained against prior instances of right and wrong answers for the User 1 to identify patterns in the User 1's emotional response patterns. Now referring to FIG. 5, an illustrative embodiment is shown for an educational gaming application using an Artificial Neural Net (ANN) as a Pattern Recognition System, a GSR sensor as the PD input, and predicting whether or not the user will answer the current question correctly. The system outlined in FIG. 5 can identify key response patterns, such as the user's Galvanic Skin Response is higher when they're about to incorrectly answer a question, or that the Facial Recognition software typically has a Happy reading of greater than 0.5 when a User 1 is going to answer the question correctly. With the above information, the education game can be modified based on the desirability of this future digital content state, or program state; is the user answering questions correctly desirable? This provides digital content system developers with the ability to program an Expert System which identifies the ideal Goals for each user based on the digital content states which can be influenced.

Still referring to FIG. 5, a developer may wish to have the user answer 75% of the presented questions correctly as a way to balance between boredom (answering all questions correctly) and frustration (User unable to answer any questions correctly). By predicting if the user will answer the current question correctly and then comparing it with the Goal function, the system can take actions based on the current digital content state and PD.

This method may represent an improvement over existing systems because by incorporating the user's PD, a more accurate representation of the User's state can be modeled, allowing the Pattern Recognition system, in this case an ANN, to model more complex interactions. From a practical standpoint, the incorporation of PD allows the system to predict right/wrong answers based on the user's emotional response as inferred through the PD. In addition, all PD may be processed without classification into a specific emotional response, which may allow the system to function without an expert system or pattern recognition system to define the user's emotion. Finally, all potential actions may be reviewed through the same prediction system, which provides an efficient way to quantify the potential impact of all of the decision system 10's available actions and then select the optimal action based on the Goal.

Potential actions may be communicated to the DCSPS 22 in the form of new or modified program state data which may be based on the program state data received from the digital content system 2. The modified program state data may be selected by the decision system 10 from amongst one or more optional program state variables each associated with [[ a particular desired future emotional response type or ]] a desired future program state being achieved. Each selected modified program state may be evaluated by the DCSPS 22 to determine the predicted probability of a future particular program state being received. For example, if the desired future program state is receiving a correct answer to a question posed to the user 1, the modified program state data may include a question associated with a particular difficulty level. Each difficulty level may also be associated with a respective probability of being answered correctly. The respective probabilities may be updated as one or more users answer the question either correctly or incorrectly. The respective probability of a selected modified program state may also be based on the user's current emotional state and the current state of the digital content system 2. For example, if the user's measured physiological data is determined to be associated with a frustrated or disinterested emotional type, the probability of the user correctly answering a difficult question may be reduced. Where the predetermined goal is to receive a correct answer from the user, the EIE 20 may therefore select a question with an easier difficulty level in this case.

To identify correlations between PD and the likely outcome of a future digital content state without any prior information about the digital content state, a pattern recognition system such as an ANN may train on past occurrences of the event. More specifically, the Pattern Recognition system would train on the PD leading up to the event to identify if there was any pattern in the user's emotional response that could be used to predict that outcome.

To reduce the number of events required and improve the responsiveness of the system, the Pattern Recognition system may train on (X+Y−1) PD examples for each event, where X<Y. In this implementation, X may be the identified time period that the system should train on based on the sensor type. For GSR sensors, this time period will be longer than for Facial Recognition software, as the user's response is expected to occur much more quickly in the latter sensor type. Y may be the period of time which the PD is expected to have been a potential indicator of the future event. For example, when trying to identify the link between PD and Question Correct, the PD that occurred 20 minutes ago is unlikely to be an indicator of the event's outcome and may not be used. In general, the closer the PD is to the event's occurrence, the more likely it is to be associated with the event's outcome.

Referring now to non-limiting exemplary figures FIG. 5a and FIG. 5b, the DCSPS 22 may be trained to predict if the User 1 will answer a question correctly based on their GSR value and the future outcome of the event. Both FIG. 5a and FIG. 5b show two training sets for the exact same occurrence of the “Question Correct” event highlighted as shown. By running through these smaller training sets, the system is looking for patterns in a User's response that may indicate the future outcome. In FIG. 5a, which is for illustrative purposes only, it can be seen that the GSR value is decreasing sharply for the 3, 4, and 5, data points in the training set. If this pattern was consistent across other Question Correct events, then this correlation may be used to predict that the user would answer a future question correctly.

### Generic Emotional Response Classification System (GERCS)

It may be possible to identify changes in a user's emotional state through the use of sensor(s) 4. Each sensor 4 may have a variety of attributes that affects its applicability for use with various Digital Content System types, as well as individual response patterns (i.e. rise time, latency, etc) that indicate a change in a user's emotional state. A user may generally respond to certain situations in the same fashion, as indicated by research into emotion classifications.

Still referring to the Sensor(s) and Filter(s) section, there are known emotion classification models in the psychological community that are constructed by using the expected response, or known state, of the user to a particular digital content state.

There may be a large number of states within a digital content system that have known attributes, referred to hereafter as Known Value States (KVS). For example, when a user answers a question correctly in an educational software package, that state can be classified as “Positive.” Similarly, if a User is playing a video game and the user's avatar dies, this state could be classified as “Negative.”

With these KVSs frequently occurring within digital content, the inventors recognized that they could be used to classify a signal from any psychophysiological sensor. Depending on the Digital Content type, the classification system can be more or less accurate. For example, if the Digital Content System were a horror game, then a user's emotional response to a digital content state specifically designed to be scary could be classified as “Scared”, rather than “Negative” or “Positive.”

The system of the present invention may use a similar method developed by researchers when investigating emotional responses, and then automate the classification process to account for variability in sensor data based on the sensor type, accommodate individual user differences, and support alternate classification systems based on the digital content state type.

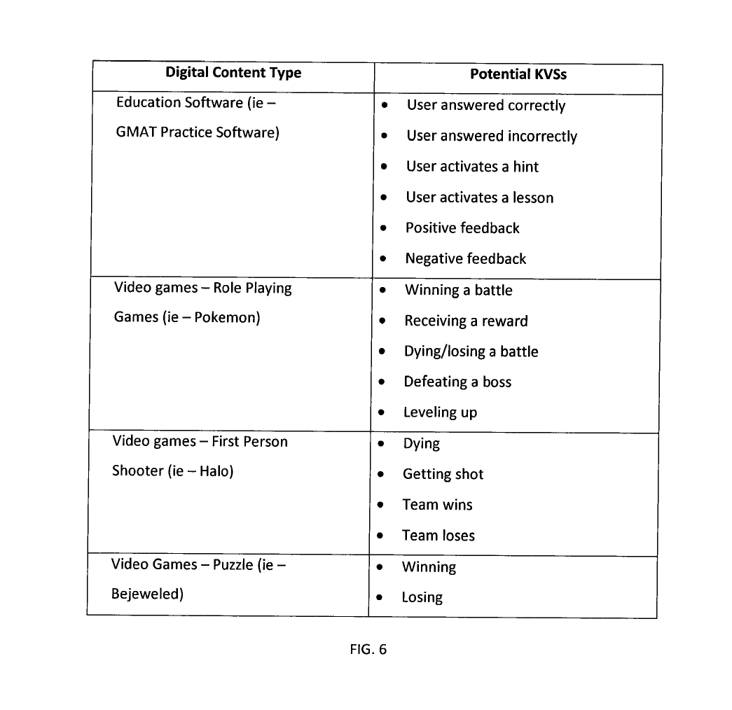

With the above information, a system and method is proposed for the classification of an individual User's emotional response based on KVS for any generic sensor providing PD. The method involves breaking a psychophysiological signal into discrete values based on a variable time step after the introduction of a stimulus and classifying them based on the KVS. As an example, a user's psychophysiological response can be monitored using Facial Recognition (FR) software in response to the introduction of a reward, an event that is classified as a “Positive” state. This process is then repeated for other KVS, such as answering a question incorrectly (“Negative” state), leveling up (“Positive” state), losing a battle (“Negative” state), answering a question correctly (“Positive”), etc. These KVS will be dependent on the type of DC, but that should not be viewed as limiting as creating a list of potential KVS is trivial. Some sample KVS based on DCS type are provided in FIG. 6 for clarity.

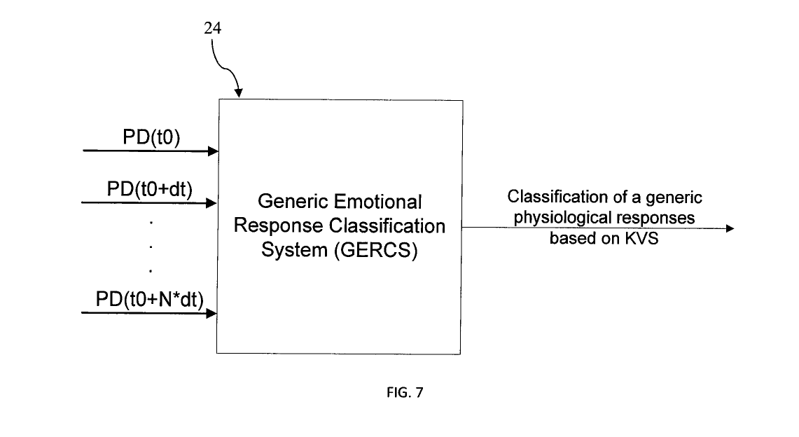

The quantifiable value of these KVS can then be reviewed based on their ability to classify a generic signal, as is done with any Pattern Recognition system. Although this system provides for the possibility of training for each User, the PD can also be filtered before being classified to improve the system's performance for a larger population. This system and method is referred to as a Generic Emotional Response Classification System (GERCS) 24, and an overview can be found in FIG. 7.

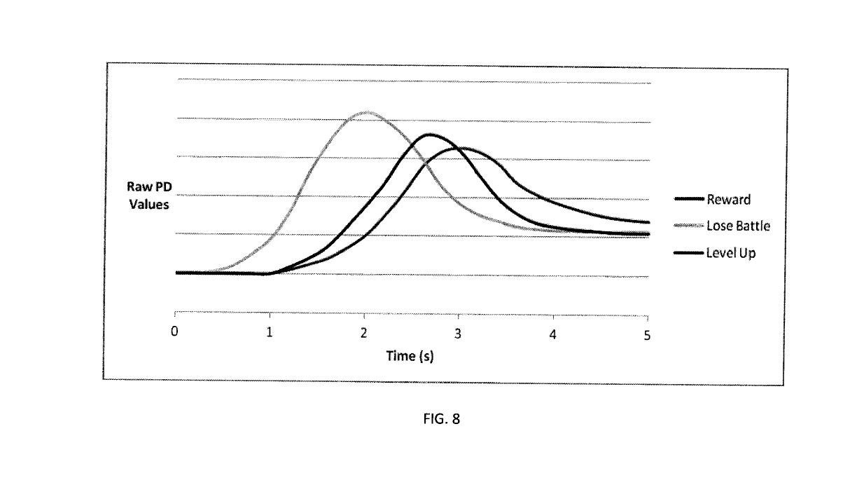

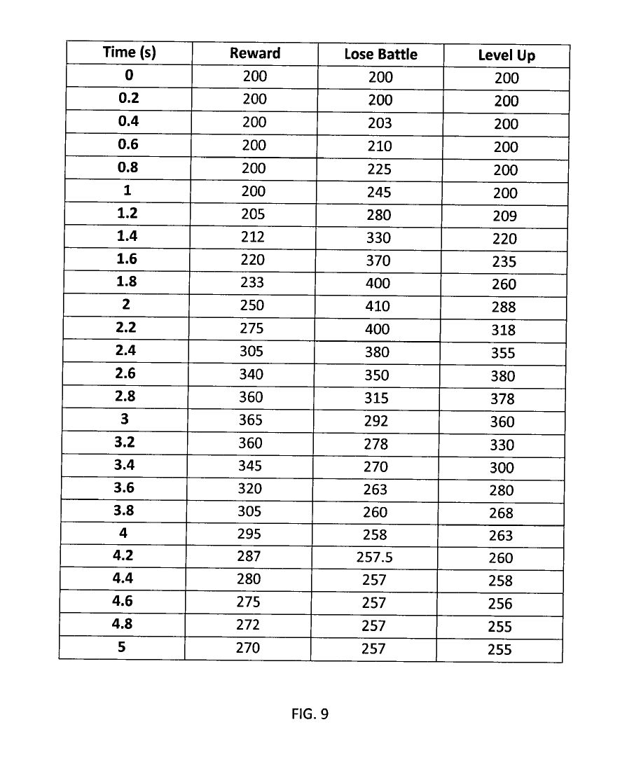

As indicated above, the GERCS 24 works by reviewing a User's PD during each of these KVS and using Pattern Recognition techniques, such as an ANN or Decision Tree, to characterize these signals as a response pattern. Referring now to FIG. 8, an illustrative example for three common KVS that appear in video games is provided along with representative emotional responses. Referring now to FIG. 9, which is for illustrative purposes only, three series of PD in response to KVS are shown. It should be noted that the data contained within FIG. 9 are the values used to generate the chart in FIG. 8, and in all instances the KVS was introduced at t(0). Using the data in FIG. 9, a pattern recognition system can be trained on each KVS to predict a time-stamped response to each stimulus.

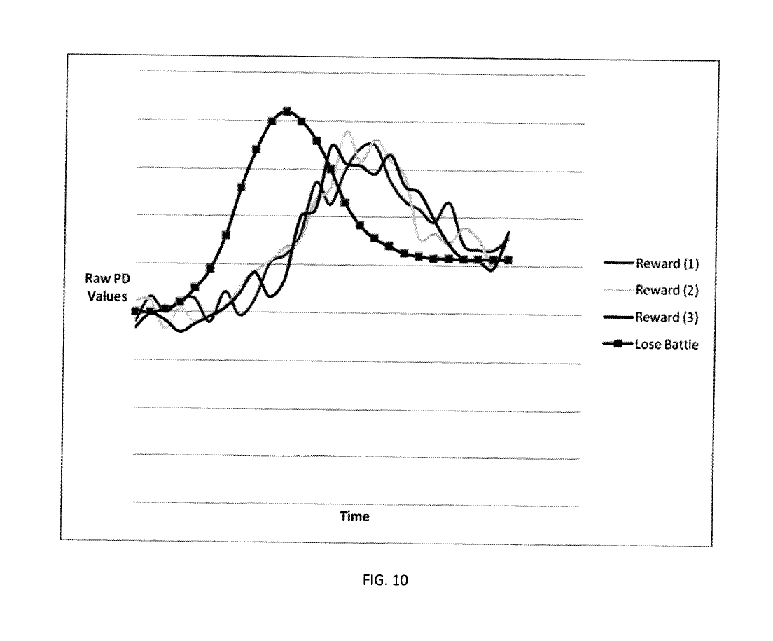

Referring now to FIG. 10, a sample of three PD series in response to a single KVS, the introduction of a Reward, are shown. In this case, the GERCS may be likely to identify certain inputs as more important to the classification of the signal. As an example, while each of the Rewards series have a different peak value, they all occur approximately 3 s after the introduction of the stimulus. Using standard techniques such as Principal Component Analysis, described at the URL http://www.imedea.uib-csic.es/master/cambioglobal/Modulo_{—}2_{—}06/Theory/lit_support/pca_wold.pdf, the contents of which are hereby incorporated by reference, the trained system can be reviewed to determine which of these inputs is the most important to the classification of the series.

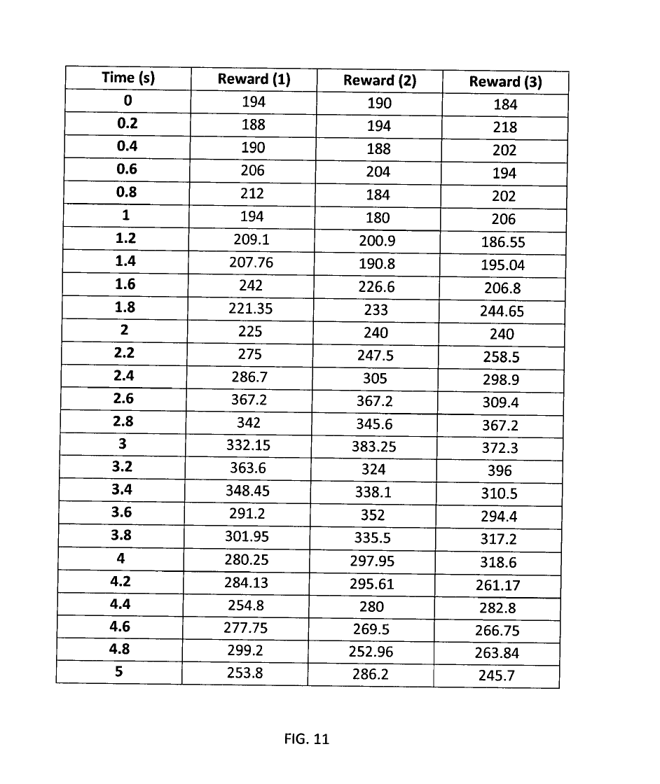

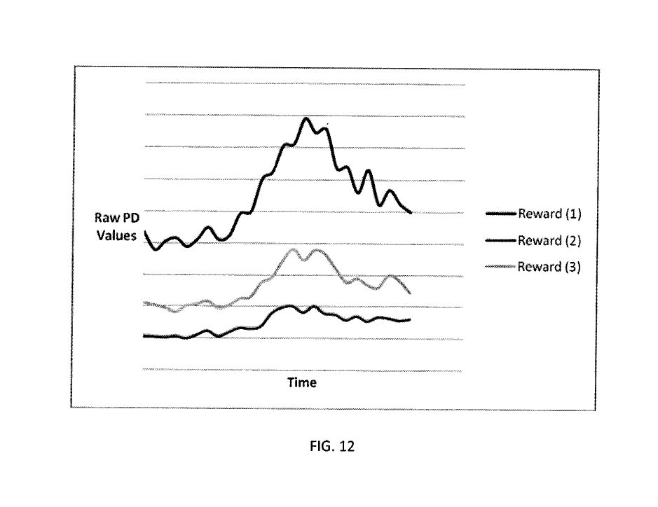

Referring now to FIG. 11, to generalize the applicability of these classifications, the data can be transformed to remove the absolute value of the data (e.g. PD readings at t=0 were 194, 190, and 184, respectively), while retaining the pertinent information. Since the data from the physiological sensors is in many cases a time series, the inventors recognized that some well-known signal classification techniques from the financial industry, which are specifically designed to isolate changes in a signal's trend, volatility, etc, could be used to improve the system's accuracy. One such example is Bollinger Bands, which can be used as a measure of volatility, and facilitate the transformation of the absolute value of a series of PD into a relative value that helps identify large changes. Referring now to FIG. 12, sample PD data for three Users is provided in response to a Reward stimulus. As can be seen from this image, each user has a very different absolute value for their PD data, which would prevent generic classification of the stimulus.

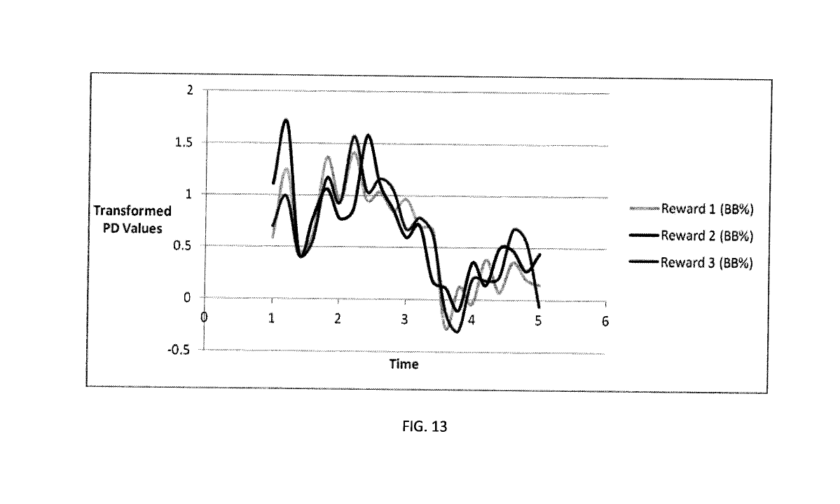

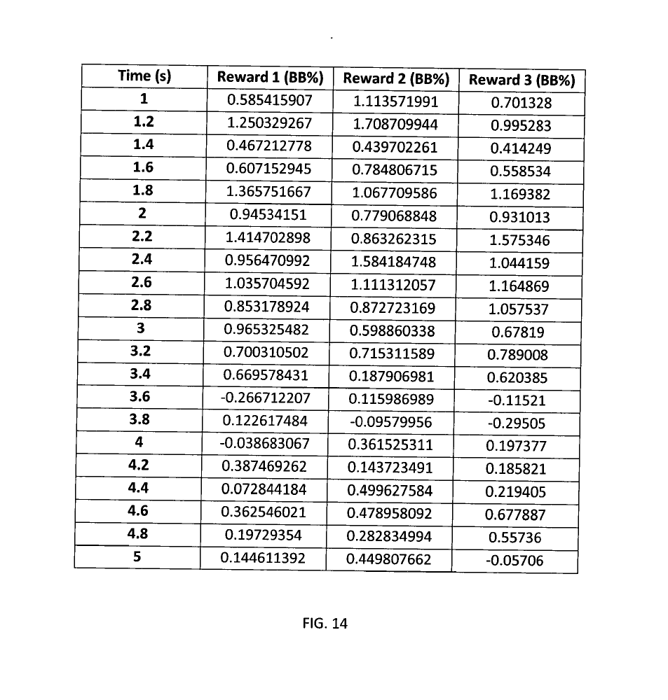

Referring now to FIG. 13, the same data has been transformed using Bollinger Bands, a 5-period moving average, and two standard deviations for band width, to highlight only the volatility of each User's response with respect to their previous PD. As can be seen from the second figure, these filtered signals provide a much more generic response pattern. The GERCS 24 can then use this information to classify PD for a new User as Positive if it exhibits the same response pattern. One additional benefit to this technique is that it allows for noisy PD to be more effectively processed. An example would be in processing a Galvanic Skin Response (GSR) sensor. These sensors measure the skin's conductivity and their readings can be influenced by external factors such as the temperature of the room the User is in. The illustrative data used to create FIG. 13 can be found in FIG. 14.

The above system may represent an improvement over the existing art for multiple reasons. Firstly, the present invention allows for the classification of any generic physiological sensor to be completed based on the digital content system type using KVS. This allows digital content system developers to quickly customize an Emotional Response System 8 when crafting a desired user experience based on the states available within the Emotional Response System 8.

Secondly, the classification system can be modified based on the digital content system type. This may allow digital content system developers to increase or decrease the classification granularity based on their individual needs. For example, when creating a simple platformer-type videogame with small levels and minimal digital content states, a developer may only want to classify the user's emotional response as “Positive” or “Negative.” Existing art, however, may only classify the user's response based on their own system, such as the FACS classification discussed in the Sensor(s) and Filter(s) section. The problem is further compounded when multiple physiological sensors are included and multiple classification methods exist.

While the accuracy of prior art in the form of research papers is limited to the size of the study group, the proposed system and method can be updated with information from all users through the filtering techniques already described. This allows for the system to train on all users of the DCS in order to improve its accuracy in classifying emotional responses specifically designed to impact the DCS. Further, by training for a system-specific implementation across a large number of users, new Users may immediately use the proposed system the first time they interact with the DCS, thus reducing the need for training.

Finally, the proposed system is advantageous in that it can be used to classify a user's future emotional responses while they interact with the digital content system 2. Once an implementation of the GERCS 24 has been trained, the GERCS can be used to augment the Emotional Response System's capabilities as outlined in Embodiment 2, below.

### Emotional Response Prediction System (ERPS)

While prior systems have outlined the idea of using a video game to alter a user's emotional response by changing in-game parameters, these systems have no ability to predict the emotional response to each individual change that the digital content system 2 can affect. These implementations were also dependent on the digital content type. As an example, prior systems have been developed that reduce the difficulty of a system in response to the identification that a user is frustrated. In this case, the assumption was made that reducing the difficulty was the appropriate response to an observed state, but no feedback loop was introduced to verify the assumption.

What the inventors recognized is that by considering each digital content state variable's change as a stimulus that induces an emotional response in isolation, a system could be developed to predict a user's emotional response to these changes. This system also alleviates the type-dependency present in other systems, as it reviews all digital content state variables independently and quantifies their ability to predict an emotional response. When used in conjunction with the GERCS 24, the ERPS 26 may provide a powerful method for predicting a user's emotional response to any change in a digital content system.

With the above information, a system and method are outlined to predict the impact of potential actions on the User's psychophysiological state. By reviewing various state changes in isolation to identify their impact on PD, the system and method allows for the prediction of emotional response patterns where no prior data exists. An example would be to review the change in PD whenever a Hint was offered in educational software. Once enough hints have been presented to the user, the system will be able to identify if there is any pattern in the user's physiological data in response to this action. This system is referred to as the Emotional Response Prediction. System (ERPS) 26.

While the ERPS 26 may consider each digital content state variable to have created an emotional response in isolation, this simplifying assumption is eliminated by increasing the accuracy requirements for the pattern recognition system. As an example, two digital content state changes, such as the introduction of a Reward and the user answering a question correctly (Question Correct), occur almost simultaneously in one instance. By filtering the user's emotional response through the GERCS 24, it's identified that their emotional response was “Positive”, but due to the proximity of the two stimuli, it would be very difficult to attribute this reaction to one state change over the other. To alleviate this problem, the ERPS 26 trains on a large number of examples for both stimuli. Continuing the example, if the Question Correct state change wasn't the true cause of the Positive classification, other occurrences of this stimulus would not yield the same PD and the ERPS 26's accuracy when being trained would decrease. This would prevent the ERPS 26 from predicting that the Question Correct DC state variable would yield a PD signal consistent with a “Positive” emotional response.

The ERPS 26 can be used to identify patterns for any DC state change which occurs frequently in the DCS. Referring again to FIG. 10, the ERPS 26 processes a signal in response to a stimulus (DC State variable change), such as the introduction of a reward. Unlike the GERCS 24, which uses this signal to classify the emotional response, the ERPS 26 uses the same PD for all DC state changes in order to predict the time-stamped PD response. Its purpose is to break the response to a DC State change into its constituent parts and determine which DC state changes, if any, are valuable for the Decision System. The impact of each DC state variable on the user's emotional estate can be quantified by the ERPS' ability to predict each step in the response pattern within a certain confidence interval.

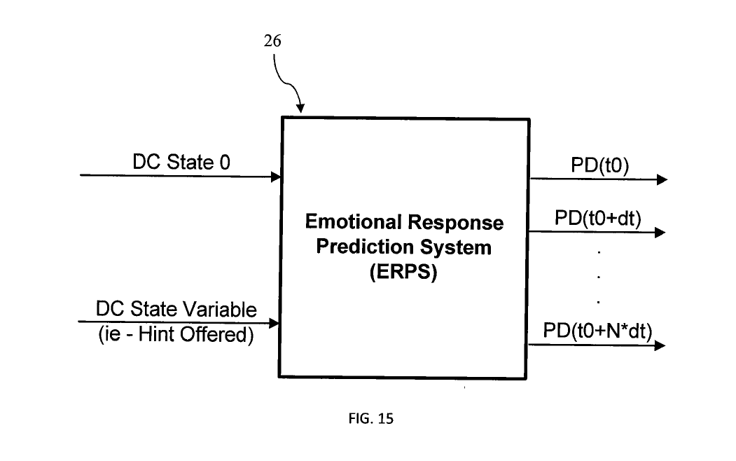

In accordance with an illustrative embodiment, FIG. 15 shows an ERPS 26 in accordance with an illustrative embodiment. Training examples for the system are identified by keeping time-stamped logs of the digital content system 2 state for each User. A simplifying assumption may be made to facilitate training: each DC State change is time independent. The system is then trained for each individual DC State variable in isolation.

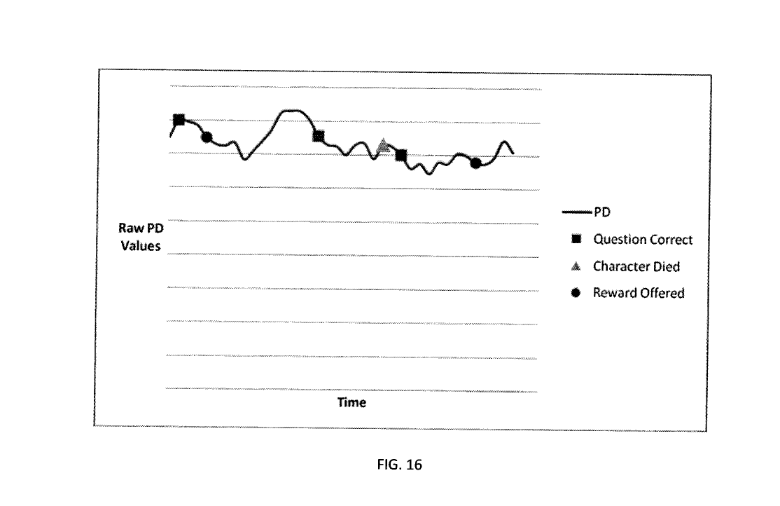

Referring now to FIG. 16, sample data has been provided to illustrate three separate digital content state Change variables: Question Correct, Character Died, and Reward Offered. The ERPS 26 would train for each of these state changes independently after a certain number of instances had occurred (e.g. 100). The number of instances would vary depending on the complexity of the pattern, therefore the proposed system would have the ability to recognize a failed classification (e.g. Classification Accuracy <70%) and wait for additional instances before retraining.

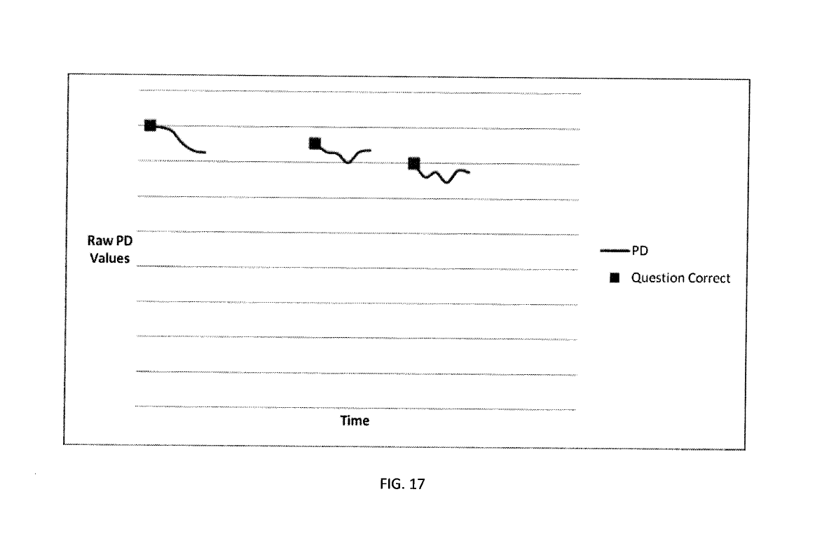

To further the example, the ERPS 26 would be trained using the three instances (along with many more) of the Question Correct state change to try to identify a pattern. A certain number of data points after the stimulus would be used, which would be dependent on the type of sensor. Although a generic value could be used here, by modifying the time step between each data point to accommodate the sensor type, the system can more accurately model the user's response. For example, FR responses occur much faster than the same response as measured by a GSR sensor. So while a time-step of 1 second may be used for the GSR sensor, a time-step of 200 ms may be more appropriate for the FR software. Referring to FIG. 17, the system would attribute the PD from the available sensors to the DC State Variable (Question Correct), and attempt to identify a pattern for each time step after the state change/stimulus occurs. Once ERPS 26 has been trained, its output can be fed into the GERCS 24 to classify the predicted emotional response to a DC State Variable change.

The system and method of the present invention may represent an improvement over existing systems for a number of reasons. Unlike systems which classify the user's emotional response in isolation, the proposed system may allow for the correlation of digital content state changes with the user's emotional response, facilitating automated classification of all digital content state changes when combined with the GERCS 24. Even further, for digital content state variables which are under the control of the Decision System 10, the EIE 20 gains an accurate estimate of how its available actions will impact the user's emotional response. This allows the EIE 20 to gain a more accurate understanding of how its actions will impact the user and therefore more effectively create a desired outcome or user experience.

The system also allows for the identification of patterns where no prior art exists because it does not require an expert to specify which digital content state variables will have the largest impact. When trained across all users of a digital content system, the system and method of the present invention may allow developers to review which state variables have the largest impact on their users, and incorporate this information into future updates. As an example, using the proposed system, a video game developer could aggregate ERPS data from all users in response to defeating a new boss, a state change which was expected to cause a large “Happy” response. If the aggregated data indicated that the average user felt “Neutral” to the stimulus, the developer would be able to redesign the system in an attempt to achieve the desired user experience.

Potential actions may be communicated to the DCSPS 22 in the form of new or modified program state data which may be based on the program state data received from the digital content system 2. The modified program state data may be selected by the decision system 10 from amongst one or more optional program state variables each associated with a particular desired future emotional response type or a desired future program state being achieved, or a weighted or un-weighted combination of both. Each selected modified program state may be evaluated by the DCSPS 22 to determine the predicted probability of a future particular program state being received. For example, if the desired future program state is to have the user express a happiness emotional response type, the modified program state data may include at least one program state variable associated with success, user-happiness, or other forward progression in the game or other application with which the user is interacting on the digital content system 2. Each program state variable may also be associated with a respective probability of any of those results being achieved, based on prior user feedback or other training data measured over time by the EIE 20. The respective probabilities may be updated as one or more users emit a measurable physiological response when presented with an indication associated with the modified program state data. The respective probabilities may also be based on the user's current emotional state and the current state of the digital content system 2. For example, if the user's measured physiological data is determined to be associated with a frustrated or disinterested emotional type, the probability of the user responding to modified program state data in a particular way may be reduced. The EIE 20 will ultimately attempt to communicate modified program state data to the digital content system 2 that has a higher probability of achieving the predetermined goal than other program state data whose probabilities were also evaluated by the EIE 20.

In general for each digital content state the ERPS 26 may identify correlations between the PD that occurred after the digital content state change. For example, if the user has received 100 Rewards in a game, the system would train for each event by looking only at the PD that occurred after each instance to see if there was a pattern in how the user reacted (e.g. every time the User 1 receives a Reward, their GSR reading increases each time step for 10 seconds). If the User 1's PD signal isn't consistent for a given stimulus, then the stimulus doesn't create a reliable emotional response and it would be classified as neutral/unknown.

### Non-Limiting Exemplary Embodiment 1

Correlation of Digital Content States with Sensor Data to Drive a Desired Outcome or User Experience

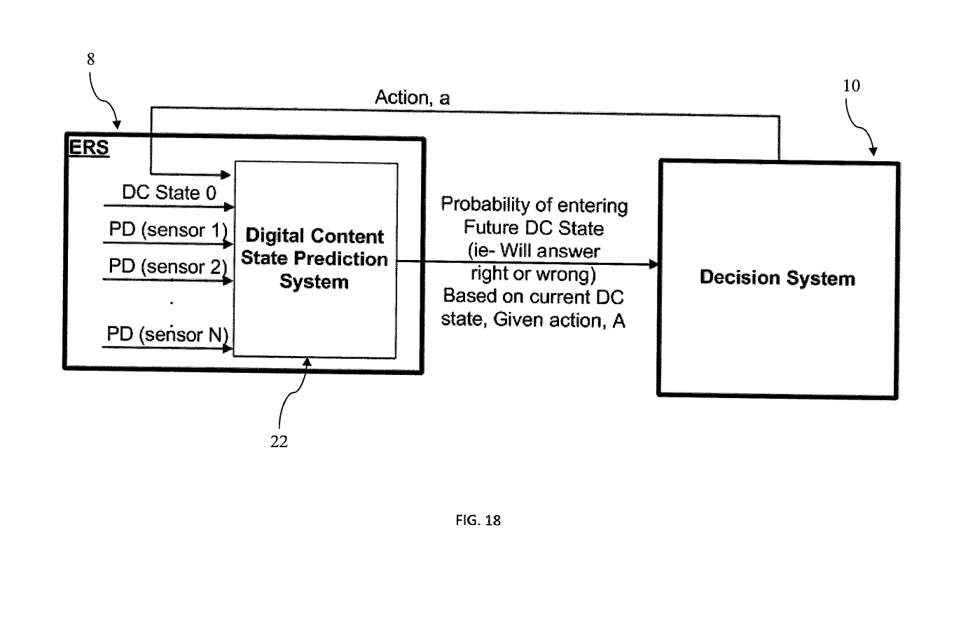

In an embodiment of the EIE 20, the system and method is comprised of a DCSPS 22 and DS 10 as outlined in FIG. 18. The DCSPS 22 receives data from a variety of physiological sensors and combines it with the digital content state to identify correlations between these two types of information in order to predict the probability of the entering a future digital content state. Using this information, the Decision System 2 is able to make decisions based on the desirability of this future state with respect to the Goal function.

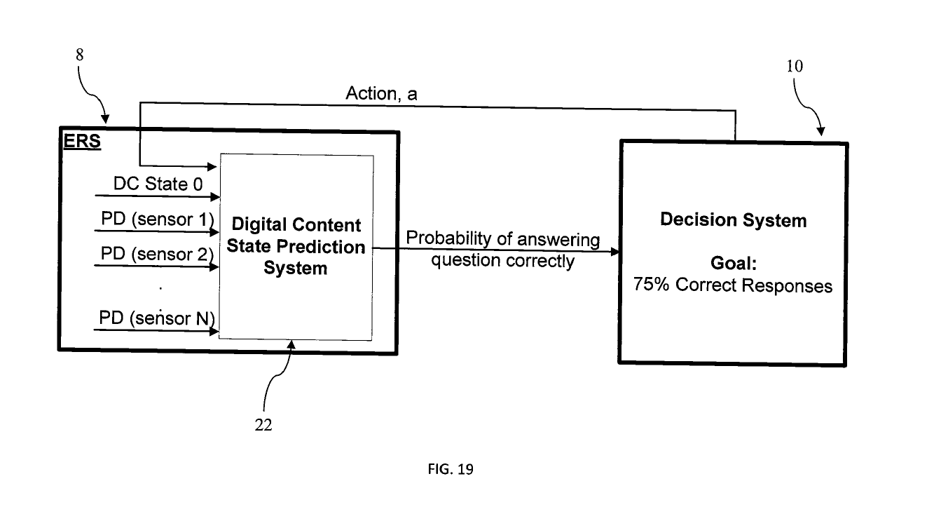

Continuing the Educational Gaming example from the section outlining the Digital Content State Prediction System 22, a User is playing an Education Game with the DCSPS 22 as the ERS 8 and a single GSR sensor supplying the PD. Due to the advantages provided by the DCSPS 22, the developer is able to set a discrete Goal for the DS 10 that allows the EIE 20 to create a desired User Experience: the user should answer 75% of the presented questions correctly. The intention here is to balance between boredom (answering all questions correctly) and frustration (User unable to answer any questions correctly). In this example, the User has already been interacting with the Education Game, and therefore the system has been trained to identify certain response patterns. An overview of this embodiment can be found in FIG. 19.

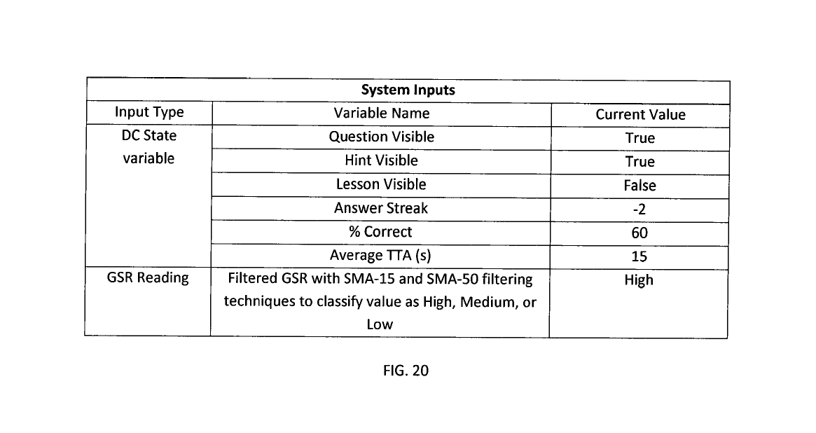

Referring now to FIG. 20, the system outlined in FIG. 19 has six digital content state variables and a single PD variable being fed into the ERS 8.

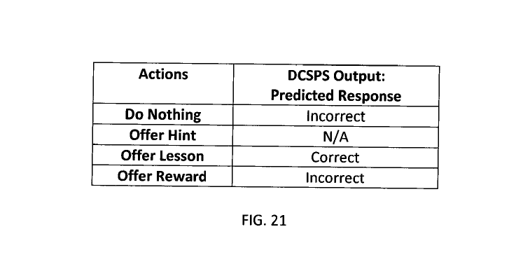

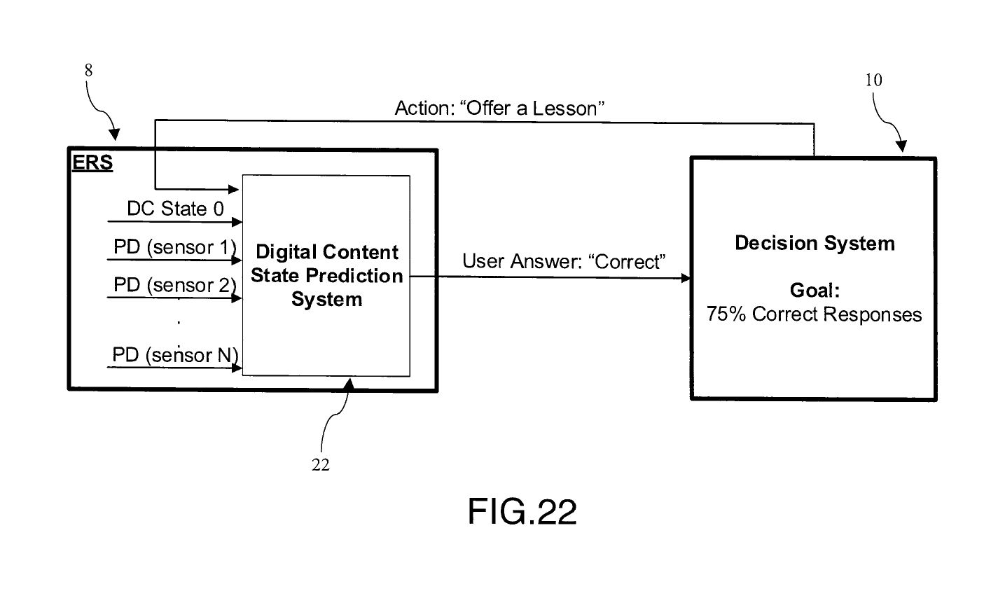

Referring now to FIG. 21, the ERS 8 has processed the system's inputs and is predicting that given the current state, the user will answer the question incorrectly. Since the Goal for this implementation is to achieve a “% Correct” of 75% and the User is currently answering only 60% of the questions correctly, the Decision System will try to induce a correct answer. Given the current digital content state and Physiological Data, there are two education-related actions that can be taken: “Offer a Lesson”, or “Do Nothing”. Referring now to FIG. 22, Since the “Do Nothing” response has been predicted to yield an incorrect response, the system can use the DCSPS 22 to review the potential effect of “Offer a Lesson” change. Since the “Offer a Lesson” action puts the Decision System closer to its goal, the Decision System will choose this action.

The proposed system and method represents an improvement over previous systems because it allows a DCS 2 to be adapted to achieve a specific goal by incorporating the user's emotional response into the decision-making process. By incorporating the user's PD into the ERS 8, the DCSPS 22 can gain a more complete picture of the user's state and more accurately predict the future state of the DCS 2. This allows the DS 10 to make a more informed decision on what potential action will create the desired outcome.

### Non-Limiting Exemplary Embodiment 2

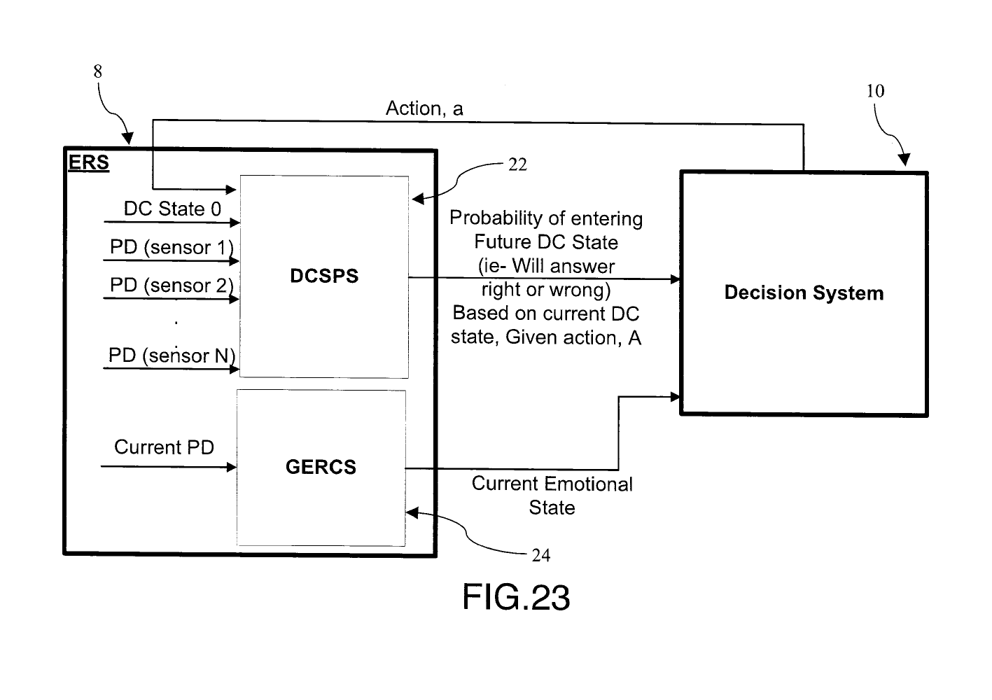

Referring now to FIG. 23, in another embodiment the GERCS 24 is extended to work alongside the DCSPS 22 as an additional component of the Emotional Response System to provide a system for predicting a future digital content state, combining it with the user's current emotional state, and feeding that information into a DS 10 to allow for more complex Goal functions. Unlike the original embodiment, this system allows DCS 2 to be more accurately controlled to create a desired user experience. An example would be the use of the system in an educational software product designed for students with Autism. For students with Autism, a primary goal is the minimization of frustration. Therefore, the system's Goal function could be extended to prioritize the minimization of frustration, while also maximizing the number of correct answers as a secondary goal.

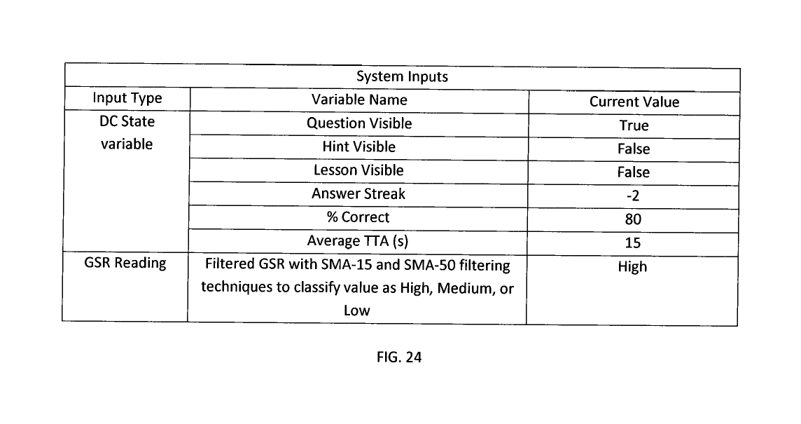

Continuing the educational software example and referring to FIG. 24, a student with Autism is playing an education game, and has answered the last two questions incorrectly. Despite this fact, they're currently answering 80% of all the questions correctly.

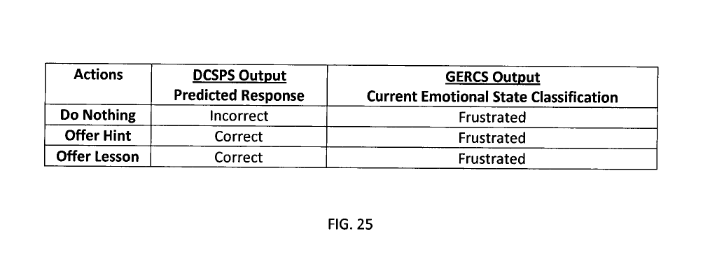

Referring now to FIG. 25, on the current question the ERS 8 is predicting that the student will answer incorrectly, and the GERCS 22 is classifying their emotional state as “Frustrated.” Since the DS 10's goal is to minimize frustration and the user is currently “Frustrated”, a review of the available actions is performed as indicated in FIG. 25. Both the “Offer Hint” and “Offer Lesson” actions are predicted to cause the user to answer the question correctly. Since the Question Correct state may be considered to be a positive KVS, either of these actions can be taken by the Decision System 10 in an attempt to improve the student's mood.

Unfortunately, there is no perfect decision in this example. By offering a Hint or Lesson to the student, the Decision System 10 will be moving farther away from its goal of having users answer 75% of questions correctly. On the other hand, by doing nothing, the student is predicted to answer the question incorrectly and enter into the KVS of Question Incorrect, which may be considered a negative KVS, thus contravening the goal of minimizing frustration. Since the Goal was written to prioritize the minimization of frustration and the performance goal was made a secondary consideration, the Decision System 10 will choose to either offer a Lesson or Hint.

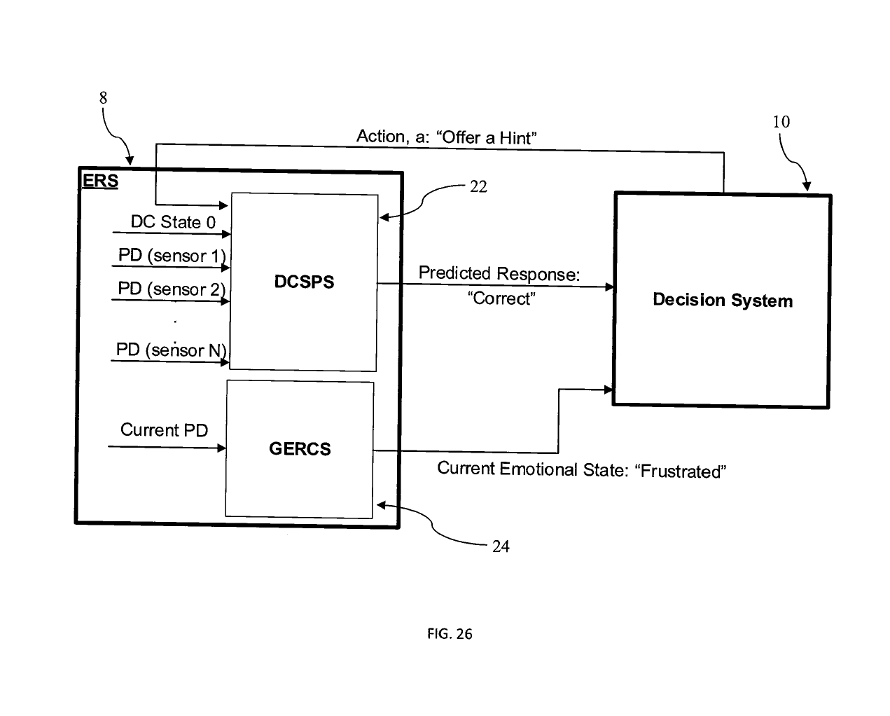

While the previous embodiment represented an improvement over existing systems, without an understanding of the user's current emotional state, the EIE 20 had no way to directly incorporate the user's emotional state into the Goal of the Decision. By adding the GERCS 22 into the ERS 8, the Decision System is provided with a more accurate picture of the user's state and can make more intelligent decisions on which actions will yield the desired user experience. Referring now to FIG. 26, a sample flow of information in the system has been provided.

### Non-Limiting Exemplary Embodiment 3

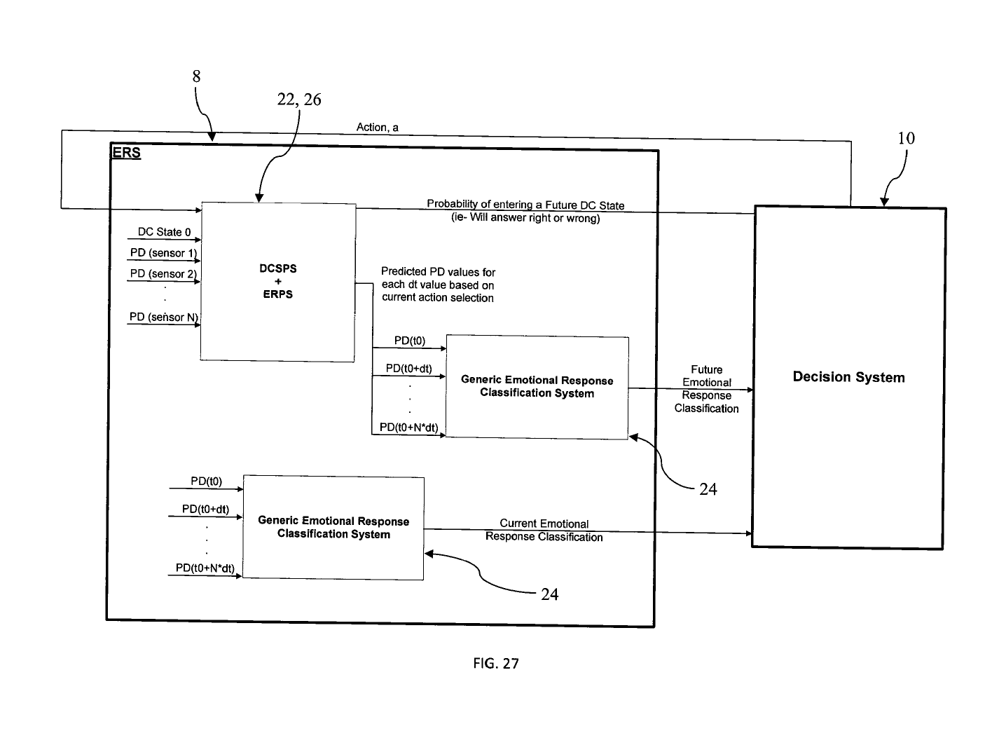

Referring now to FIG. 27, in another embodiment, a system and method are proposed that incorporate the GERCS 24, DCSPS 22, and ERPS 26 to extend the Decision System 10's ability to create a desired outcome and user experience. With the introduction of the ERPS 26, the DS 10 can run through its list of potential actions to determine what the likely digital content state will be and what the expected emotional response will be for the User 1, and then compare that information with the current digital content state and emotional state to determine if that action will better satisfy the Goal function.

Extending the Autism example from before and referring again to FIG. 25, by combining these three novel systems, the Decision System 10 can select a desired action that has already been shown to reduce frustration. In the prior implementation, the system could only choose an action based on the fact that the User 1 was frustrated, without being able to quantify the potential change in emotional state for each available action. Its decision was based entirely on the expected value of the available actions, which limits the ability of the embodiment to intelligently adapt the DCS 2 in order to create a desired outcome and user experience.

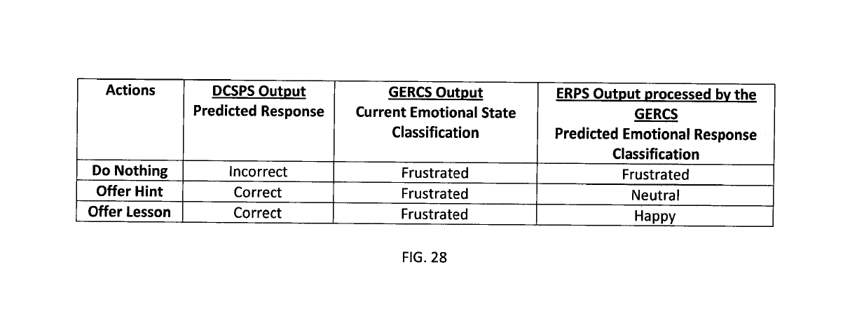

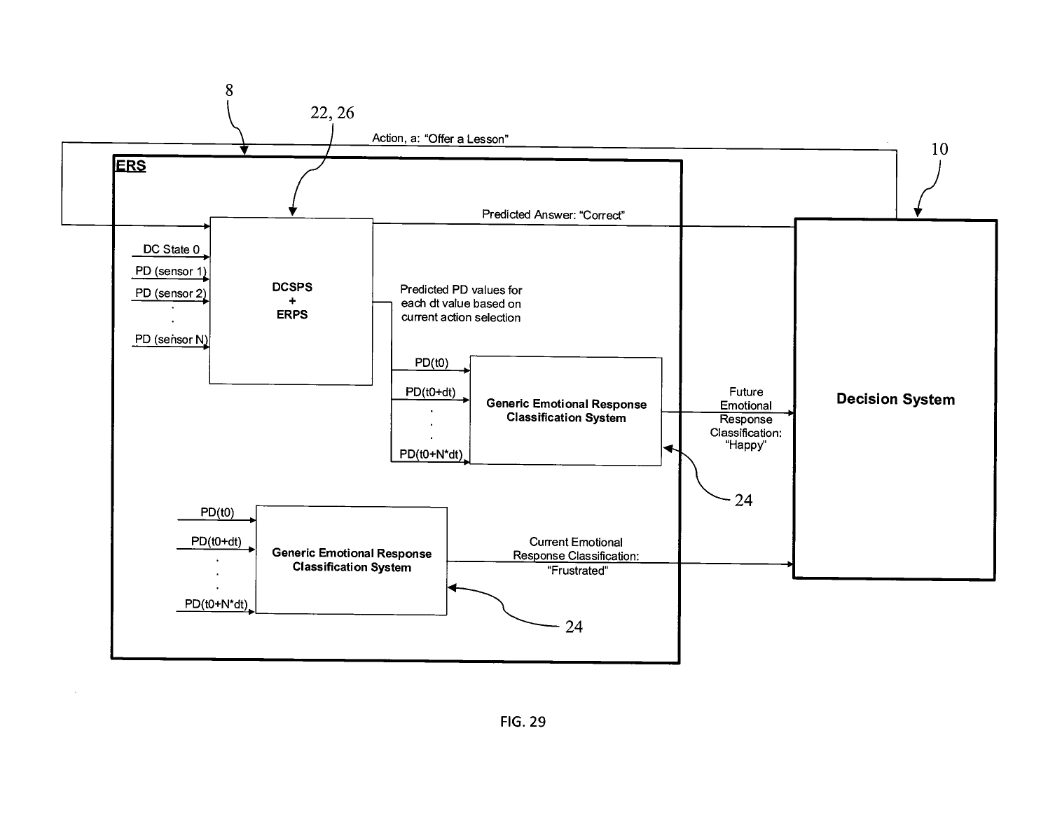

Referring now to FIG. 28, the additional information provided by the ERPS 26 allows the DS 10 to make a more intelligent decision as to which action it should take. In the previous example, both the “Offer Lesson” and “Offer Hint” actions were considered equally given that their perceived value was based entirely on their classification as a KVS. In this example, the ERPS 26 has already been trained for this User, and has been able to classify the user's expected PD data for both the Hint and Lesson state changes. Referring again to FIG. 28, the User's expected emotional response, after being classified by the GERCS 24, is “Neutral” and “Happy” for “Offer a Hint” and “Offer a Lesson”, respectively. Since the goal is to minimize frustration, the system can now intelligently select the “Offer Lesson” action to help put the User in a positive emotional state. FIG. 29 outlines the flow of information through the EIE 20 for the provided example.

In aggregate, the proposed system represents a significant improvement over existing systems. The DCSPS 22 can be trained for a generic DCS 2 to predict changes in digital content state and enable the intelligent review of potential actions. The GERCS 24 provides the EIE 20 with the ability to classify the user's emotional state. The GERCS 24 also allows the system to be trained for specific DCS 2 rather than relying on prior art for the classification system. Finally, the ERPS provides a means of predicting how a user's PD will change for each digital content state change. This information is fed into the GERCS 24 for classification, thus providing the EIE 20 with a predicted future emotional response for each action at its disposal. By accurately predicting the user's behaviour, classifying their emotional state, and predicting their emotional response for each available action, the proposed system and method allows for DCS 2 to be intelligently controlled to achieve a desired outcome and user experience.

### Non-Limiting Exemplary Embodiment 4

### Local API

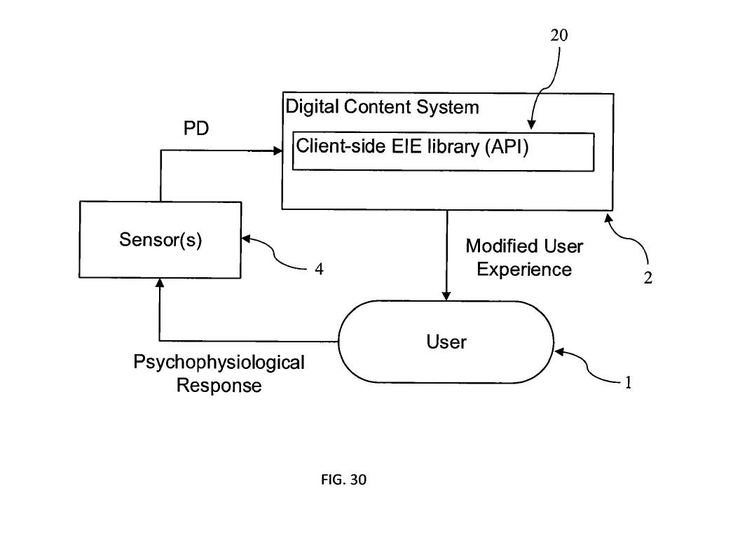

In a non-limiting exemplary implementation, all or part of the functionality of the EIE 20, including all or part of each of the decision system, GERCS 24, DCSPS 22, and ERPS 26 may be resident in and executed from within the digital content system itself. In one embodiment of the system and method, the EIE 20 may be implemented as a library that is included in a Digital Content System 2, as illustrated in FIG. 30. In this embodiment, the sensor(s) send physiological data directly to the digital content system, which utilizes an API function to send it to the built-in EIE 20. In turn, the EIE 20 recommends changes to the digital content through another API function, in order to achieve a desired outcome or user experience. Physiological data is stored within the EIE 20, and the EIE 20 is responsible for periodically updating and training based on data provided by the Digital Content System 2. This embodiment has the advantage of obstructing the logic of the EIE from a third-party Digital Content System 2 and simplifying interactions with the EIE 20 through API functions. For an example, refer to non-limiting exemplary use case 6, below.

### Non-Limiting Exemplary Embodiment 5

### Cloud-Based EIE

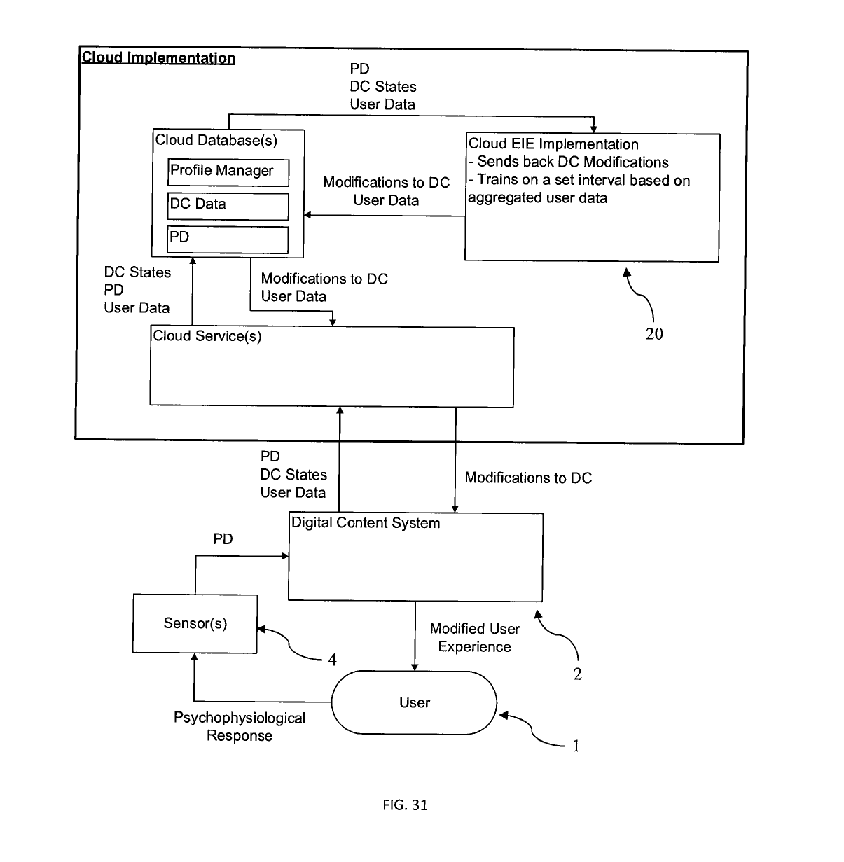

In another embodiment of the system and method, the EIE 20 may be included in a cloud implementation, as illustrated in FIG. 31. In this embodiment, the one or more sensors send physiological data directly to the Digital Content System 2. The Digital Content System 2 sends physiological data, digital content states, and user data to one or more cloud services, which store the data in one or more cloud databases. In turn, the cloud EIE 20 implementation processes the data for each individual user and recommends changes to the digital content for that user in order to achieve a desired outcome or user experience. The recommended changes to the digital content are stored on the database(s) and send to the Digital Content System 2 through the cloud service(s).

Still referring to FIG. 31, in one aspect, the EIE 20 is able to train based on data stored in the cloud database(s) for an individual user.

Still referring to FIG. 31, in another aspect, the EIE 20 is able to train based on aggregate data stored in the cloud database(s) for more than one user.

By maintaining and accessing data obtained from a plurality of users, the EIE 20 may take advantage of leveraging the larger data set from the distributed user base, which may allow the system to find a generalized optimal EIE 20 configuration, identify more complex patterns, and avoid ‘over-training’ (or ‘over-fitting’), which is a known problem for artificial intelligence implementations. For an example, refer to Non-Limiting Exemplary Embodiment Use Case 7, below.

### Non-Limiting Exemplary Embodiment 6

### Local API and Cloud Training System

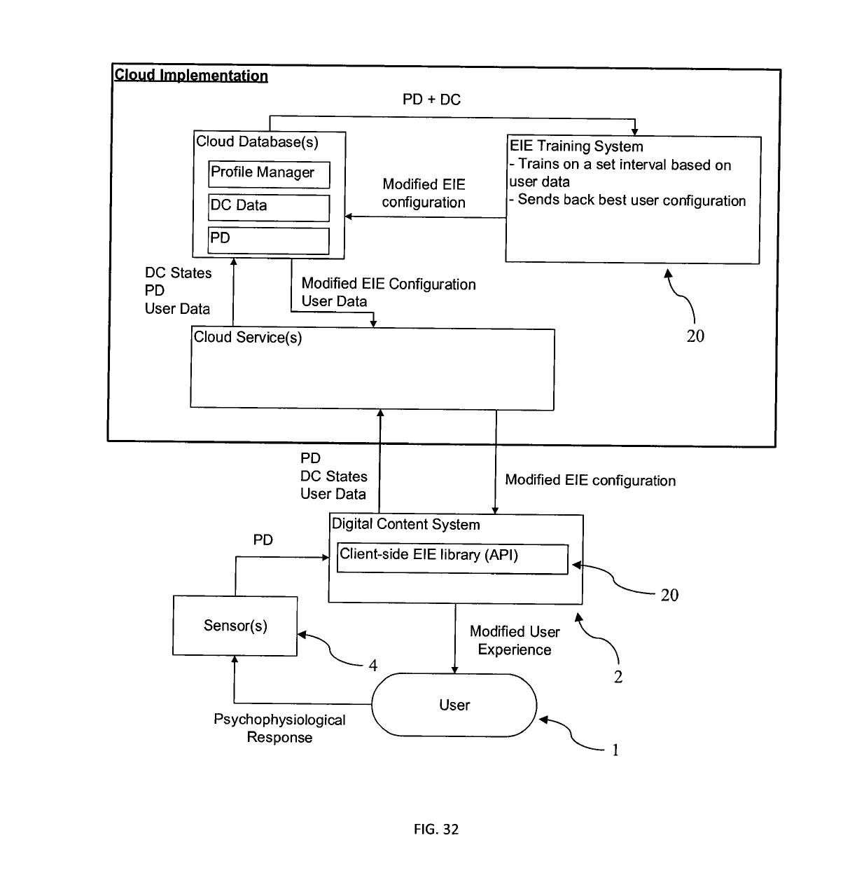

In yet another embodiment of the system and method, the EIE 20 is implemented as a library that is included in a Digital Content System 2, as illustrated in FIG. 32. In this embodiment, the sensor(s) send physiological data directly to the digital content system, which utilizes an API function to send it to the built-in EIE 20. In turn, the EIE 20 recommends changes to the digital content through another API function, in order to achieve a desired outcome or user experience. Physiological data is stored within the EIE 20, and the EIE 20 is responsible for periodically updating and training based on data provided by the Digital Content System. In addition, the Digital Content System also sends physiological data, digital content states, and user data (which can be stored in the local EIE 20) to one or more cloud services, which store the data in one or more cloud databases. In turn, the cloud-based EIE Training System utilizes methods similar to those described for the generalized EIE 20 under the heading “Emotional Response System and Decision System” to train based on data stored in the cloud database(s) for one or more users. It then sends a modified EIE configuration (e.g. modified classification method) to the Digital Content System 2 through the Cloud Database(s) and Cloud Services(s).

Still referring to FIG. 32, this embodiment has the advantage of leveraging a larger data set from a distributed user base to train a generalized EIE configuration, but also operating the EIE locally to minimize data transfer between the Digital Content System 2 and the Cloud Implementation. For an example, refer to Non-Limiting Exemplary Use Case 8, below.

### Non-Limiting Exemplary Use Case 1

For education, an online children's educational game may implement the present system and method to teach elementary math skills (e.g. addition, subtraction, multiplication, and division). Emotions would be monitored using a physiological wristband sensor measuring GSR which is attached to the child. The desired outcome is to master as many math skills as possible in the current session. The EIE 20 would monitor the child's frustration and engagement level, in addition to their progress in the game. If the child is getting frustrated and is also struggling with content, the game would be able to offer a hint or lesson for the present math skill to help them understand. If the child was getting very frustrated, the game could replace the math question with an easier question. If frustration decreases and the child is doing well, the EIE 20 would make the level of math questions harder to make the game more challenging and prevent boredom. This would have the advantage of circumventing high levels of frustration in the child, which research has shown to be detrimental to learning.

### Non-Limiting Exemplary Use Case 2

Also in education, an online children's game designed for children with Special Needs (e.g. autism, dyslexia, Down syndrome, etc.) may implement the present system and method to teach elementary math skills (e.g. addition, subtraction, multiplication, and division). The desired user experience would be to keep the child in a calm emotional state (i.e. avoid frustration). Emotions would be monitored using a multi-sensory wristband, measuring GSR, heart rate, skin temperature, and movement, which is attached to the child. The EIE 20 would monitor the child's frustration and engagement level, and when frustration increases, the game would change the question content to make it easier, or remove the child from the current challenge until they calm down. If frustration decreases and the child is doing well, the EIE 20 would progress through new educational content. While this illustrative use case is similar to the one above, research has shown that some children with Special Needs are very sensitive to changes in emotional state, and that frustration is especially detrimental to the child's learning. Thus, this system would prioritize keeping a child in a calm emotional state over the mastery of new content, which would allow it to personalize its actions for the unique requirements of Special Needs students.

### Non-Limiting Exemplary Use Case 3

Also in education, an online learning software designed to assist students in studying for a test, such as a standardized test, including the Graduate Management Admission Test (GMAT) (commonly used by business schools in the United States as one method of evaluating applicants) may implement the present system and method to teach and reinforce the various educational components of the GMAT. Emotions would be monitored using a facial recognition software which would use a computer-mounted camera. The desired outcome is to achieve mastery in all of the educational content. The EIE 20 would monitor the student's frustration and engagement level, in addition to their progress in the educational content. If the student was answering questions correctly, the software would keep increasing the difficulty of the content until the student started getting a significant portion of it wrong or was very frustrated. If the student was not frustrated and was answering questions incorrectly, the system would substitute the educational content for pre-requisite content. This system would have the advantage of maximizing the amount of new content learned by continuously challenging the student with content which is new and difficult, while ensuring the student does not get overly frustrated and quit.

### Non-Limiting Exemplary Use Case 4

Also in education, a business training software for new employees to learn the practices and policies (e.g. compliance policies for personal financial transactions for employees of a Financial Institution) of a corporation may implement the present system and method to ensure that all of the content was covered. Emotions would be monitored using a computer mouse with multiple physiological sensors built in, which would detect GSR and skin temperature from the user's fingers. The desired outcome is to achieve mastery in all of the educational content. The EIE 20 would monitor the user's emotional state and their progress through the content. The EIE 20 would observe what elements of the content the user found ‘engaging’ and what elements of the content the user found ‘boring’, and would then alternate between ‘boring’ and ‘engaging’ content so that the user does not get overly bored. Research has shown that boredom could cause a user to disengage with the educational content, and in turn impede learning. This system would have the advantage of minimizing boredom to maximize the amount of content the user progresses through.

### Non-Limiting Exemplary Use Case 5

In the context of gaming, an illustrative example of utilizing the present system and method would be for integration with online Java-based Role Playing Games (RPG) where users have a wizard avatar and battle opponents and other characters to become more powerful. Emotions would be monitored using a facial recognition software using a computer-mounted camera, and a multi-sensory wristband, measuring GSR, heart rate, skin temperature, and movement, which is attached to the user. The objective of the system is to promote a user experience with maximum engagement at all times. An emotional response system would monitor the user's engagement level in the game. Whenever the user's engagement level is dropping, game-play mechanics and content would be changed so that the user became re-engaged. Examples would include increasing the sound volume and haptic feedback in the game, temporarily increasing or decreasing the user's avatar's power in a battle, and varying the opponents that the user encountered. In addition, any game mechanic that relies on chance (e.g. whether or not the player's attack ‘misses’ their opponent) can be manipulated by the present system and method. The EIE 20 would then monitor the user's reaction to the feedback, and learn what modifications have the largest impact on the user's engagement level.

### Non-Limiting Exemplary Use Case 6

Also in gaming, a mobile phone game such as an automotive racing game for the Apple iPhone using the iOS operating system may implement the present system and method as an Application Programming Interface (API) library to determine which in-game rewards (e.g. gaining virtual currency, winning a new car, winning racing tires for their existing car, etc.) resulted in a large emotional arousal in the user. Emotions would be monitored using a multi-sensory wristband, measuring GSR, heart rate, skin temperature, and movement, which is attached to the user. The desired outcome is to determine the ‘value’ of in-game rewards by tracking a user's emotional arousal to them, and then prioritizing assignment of specific rewards in the game according to their assessed value. The EIE 20 would monitor the change in the user's emotional state when the user was given a reward, and monitor the user's reaction. This system would have the advantage of figuring out what rewards the user ‘values’, and making more intelligent decisions of when it assigns the rewards.

### Non-Limiting Exemplary Use Case 7

Also in gaming, the present system and method could be utilized for interaction with a console-based RPG, where users have a wizard avatar and battle opponents and other characters to become more powerful. The console, such as a Sony PlayStation 3, would interact with a cloud-based EIE 20. Emotions would be monitored using sensors integrated into a handheld video game controller, measuring GSR, heart rate, skin temperature, and movement, which is attached to the user. The objective of the system is to promote a user experience with maximum engagement at all times. The console would send physiological data to the cloud-based EIE, which would monitor the user's engagement level in the game. Whenever the user's engagement level is dropping, the cloud-based EIE 20 would tell the console to alter game-play mechanics and content so that the user became re-engaged. Examples would include increasing the sound volume and haptic feedback in the game, temporarily increasing or decreasing the user's avatar's power in a battle, and varying the opponents that the user encountered. The EIE would then monitor the user's reaction to the feedback, and learn what modifications have the largest impact on the user's engagement level. This system would have the advantage of aggregating data from several users in a distributed manner.

### Non-Limiting Exemplary Use Case 8

Also in gaming, a mobile device game such as Tetris for the Google Nexus 7 tablet using an Android operating system may implement the present system and method as a local API library used for classification, and a larger cloud-based EIE 20 (with a similar API) used for training. The game would visually display its user's emotional arousal level on the tablet's display screen. Emotions would be monitored using a facial recognition software utilizing a camera built into the tablet device. The desired outcome is to make the user aware of their emotional arousal level as the user is interacting with the game. The tablet would use the local API to determine a user's arousal and display this information to the user. The tablet would also store raw physiological data from the user, and when an internet connection was available, it would send aggregated data to a cloud-based EIE 20. Having received data from multiple users, the cloud-based EIE would train and improve its classification system, and send the information for the updated classification system to the tablet. This system would have the advantage of aggregating training data from several users in a distributed manner, while still allowing the system and method to be run locally in the absence of a connection to the cloud-based EIE 20.

In any of the implementations of the present system and method described, the goal may be a representation of the Digital Content System 2 developer's desired outcome or user experience for the User 1. The Goal provides a way for the developer to represent this experience given the amount of information present in the EIE 20. For example, if the developer is only incorporating the DCSPS 20, then the Goal may be limited to digital content states that are expected to influence the user's emotional state (e.g.—Write or wrong answers). If the developer incorporates the GERCS 24 and ERPS 26, then higher level goals can be set. In many cases, the goal needs to be turned into a system that can output a number. This can be done in a variety of ways including simple case statements for each component of the goal such as if the user is ‘Frustrated’, then their Emotional State=−2, if the user is ‘Neutral’, then their Emotional State=0, if % correct !=Goal, then Performance State=Absolute ((Current % Correct)−Target % Correct))/Scaling Factor, where the scaling factor will depend on the relative importance of the outcome State (e.g. “Answer 75% of questions correctly”) with respect to the User Experience state (“Minimize frustration”). This may also optionally be done by a fuzzy system for turning the outputs of the digital content system 2 into a value, or through reinforcement learning systems which contain a Reward and/or Value function to evaluate each state's “value” with respect to the goal. Some additional possible non-limiting examples include: (i) in a learning context, the goal could be to master specific topics; (ii) in a gaming context, the goal could be limited to trying to maximize Engagement (or as Maximizing a user's emotional arousal and ensuring that it is of a positive emotional valence); (iii) in a training software program, the goal could be to minimize the time taken to master new skills, while minimizing Negative DC states; (iv) in a horror game, the goal could be to maximize the time a User spends in a “Scared” or “Surprised” state; (v) if the Digital Content is a video game, the goal could be to maximize the User's average session length (here, the use of aggregated data may be required, as external influences, such as the user quitting to go to the movies, would have a larger impact on the EIE 20); and (vi) for a video game, an alternate user goal could be to minimize boredom.

Once the EIE 20 has determined that modified program state data, or digital content modifications, are associated with particular user experience outcomes, the EIE 20 may select amongst multiple modified program state data that may each be associated with the same outcome. In accordance with aspects of the present invention, the general process may be to initiate a “Potential Action Review”, and then quantify how each predicted outcome will satisfy the goal. This is known as the expected state's “value” as would be found in a Reinforcement Learning implementation. In that case, the Goal function will strongly impact which decision is best. For example, if the Goal is set to minimize frustration while maximizing content learned, the weights associated with these two competing goals will impact how each action is viewed. The examples above highlight this point, but in general the Decision System 10 will turn the current state into a value, compare it with the perceived value of the potential future states, and then select the action which leads to a state of maximum value.

In a simple implementation, when two states have the same value associated with them, the process may be to randomly select between the available options. The example for Embodiment 2 highlights this situation, where because the system doesn't have enough information to discern difference in the impact of Offering a Lesson or Offering a Hint on the user's emotional response, it may randomly pick one of the two best options.

To create a more intelligent system, online training algorithms which can deal with a wide variety of DC states and train on-line (e.g. Reinforcement Learning algorithms) should be used. In that case, the DS 10 system could have a reward function, which would review digital content states and then select an action that would maximize the short term reward. At some terminal state, which would be digital content system 2-dependent, the system would review how well it had accomplished the Goal through the use of a Value function. As the system progresses through various digital content states, the reward it receives from the Reward function will be used to update that state's value.

Referring again to Example 1, the Reward function could reward the DS 10 whenever the user answers a question from an “unmastered” skill correctly and punish the system when they answered incorrectly in order to achieve a performance outcome (“Maximize new skills learned”). In addition, the Reward function may punish the DS 10 for any action that led to the user becoming “Frustrated”, while rewarding any action that caused the User to enter or maintain a “Happy” state. In the above case, the weights assigned to each of these Reward types in the Reward function will be dependent on the overall goal (i.e. the reward function will require a larger weight for keeping a User in a Happy state than for them answering a question correctly if the goal is to primarily maximize Happiness).

Extending the example, a Value function could be used to initiate a review of the system whenever a user mastered a new skill. If for a particular skill the user answered 1,000 questions, logged 3 in-game hours, and was frustrated approximately 50% of the time, then the Value function may consider this a Negative outcome, and each of the states that led to the outcome would have their value reduced. Since the value of these states would be reduced, the DS 10 would be less likely to select the actions leading to those states when making decisions in the future.

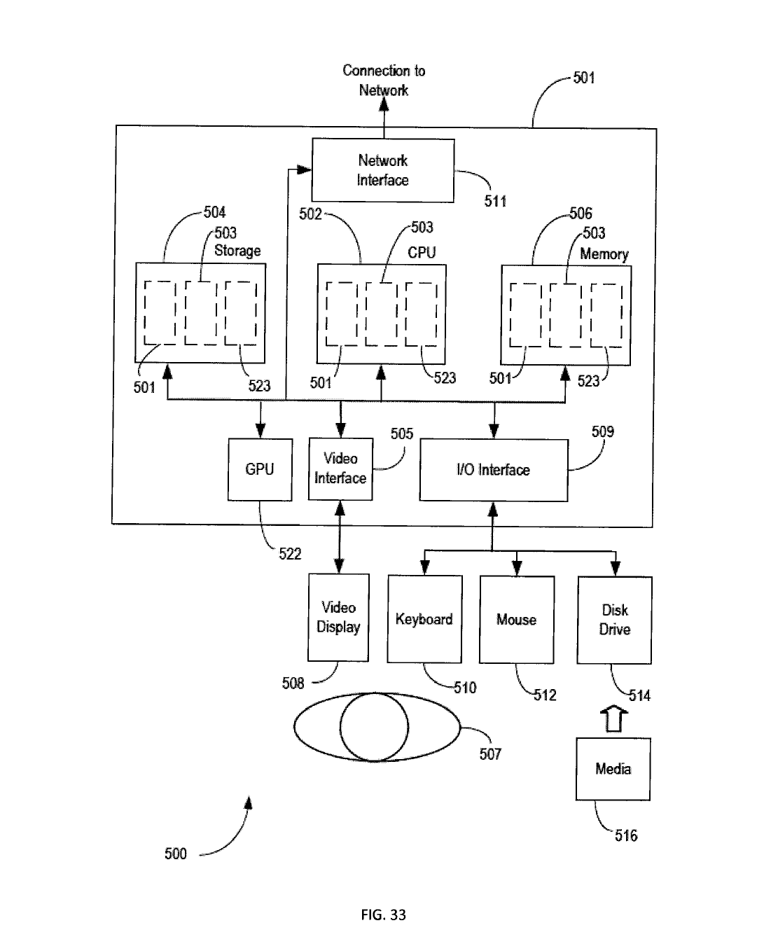

The present system and method may be practiced in various embodiments. A suitably configured computer device, and associated communications networks, devices, software and firmware may provide a platform for enabling one or more embodiments as described above. By way of example, FIG. 33 shows a generic computer device 500 that may include a central processing unit (“CPU”) 502 connected to a storage unit 504 and to a random access memory 506. The CPU 502 may process an operating system 501, application program 503, and data 523. The operating system 501, application program 503, and data 523 may be stored in storage unit 504 and loaded into memory 506, as may be required. Computer device 500 may further include a graphics processing unit (GPU) 522 which is operatively connected to CPU 502 and to memory 506 to offload intensive image processing calculations from CPU 502 and run these calculations in parallel with CPU 502. An operator 507 may interact with the computer device 500 using a video display 508 connected by a video interface 505, and various input/output devices such as a keyboard 510, mouse 512, and disk drive or solid state drive 514 connected by an I/O interface 509. In known manner, the mouse 512 may be configured to control movement of a cursor in the video display 508, and to operate various graphical user interface (GUI) controls appearing in the video display 508 with a mouse button. The disk drive or solid state drive 514 may be configured to accept computer readable media 516. The computer device 500 may form part of a network via a network interface 511, allowing the computer device 500 to communicate with other suitably configured data processing systems (not shown).

In further aspects, the disclosure provides systems, devices, methods, and computer programming products, including non-transient machine-readable instruction sets, for use in implementing such methods and enabling the functionality described previously. The system and method of the present invention may be implemented in one computer, in several computers, or in one or more client computers in communication with one or more computer servers.

Although the disclosure has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

Except to the extent explicitly stated or inherent within the processes described, including any optional steps or components thereof, no required order, sequence, or combination is intended or implied. As will be will be understood by those skilled in the relevant arts, with respect to both processes and any systems, devices, etc., described herein, a wide range of variations is possible, and even advantageous, in various circumstances, without departing from the scope of the invention, which is to be limited only by the claims.

What is claimed is:

1. A method, performed by a computing device in communication with at least one sensor, comprising:
receiving physiological data from the at least one sensor, the physiological data representative of a user emotional response measured by the at least one sensor;
correlating the received physiological data with program state data, each of the received physiological data and the program state data associated with a predetermined time interval;
determining an emotional response type corresponding to the received physiological data by comparing the received physiological data with at least one physiological data profile associated with a predetermined emotional response type; and
providing an indication associated with modified program state data, the modified program state data based at least partly on the program state data and the determined emotional response type.

2. The method of claim 1 wherein the program state data comprises a program state data value corresponding to a respective user input at the second computing device.

3. The method of claim 2 comprising:
determining a probability of receiving a subsequent program state data value, the probability determining based at least partly on the determined emotional response type and the received program state data;
wherein the modified program state data is based at least partly on the determined probability.

4. The method of claim 2 comprising:
determining a probability of receiving subsequent physiological data corresponding to a subsequent emotional response type, the probability determining based at least partly on the determined emotional response type and the received program state data;
wherein the modified program state data is based at least partly on the determined probability.

5. The method of claim 3 wherein the probability determining is also based at least partly on a selected predetermined program state data value associated with the determined emotional response type and the received program state data.

6. The method of claim 4 wherein the probability determining is also based at least partly on a selected predetermined program state data value associated with the determined emotional response type and the received program state data.

7. The method of claim 3 comprising:
determining a second probability of receiving the subsequent program state data value, the second probability determining based at least partly on the determined emotional response type, the received program state data, and a selected predetermined program state data value associated with the determined emotional response type and the received program state data; and
in accordance with a comparison of the determined second probability to the determined probability, updating the modified program state data in accordance with the selected predetermined program state data value.

8. The method of claim 4 comprising:
determining a second probability of receiving the subsequent physiological data corresponding to the subsequent emotional response type, the second probability determining based at least partly on the determined emotional response type, the received program state data, and a selected predetermined program state data value associated with the determined emotional response type and the received program state data;
in accordance with a comparison of the determined second probability to the determined probability, updating the modified program state data in accordance with the selected predetermined program state data value.

9. The method of claim 5 wherein the selected predetermined program state data is selected from a sequence of program state data, the sequence comprising a predetermined sequence order; the method comprising re-ordering the predetermined sequence order in accordance with the probability determination.

10. The method of claim 6 wherein the selected predetermined program state data is selected from a sequence of program state data, the sequence comprising a predetermined sequence order; the method comprising re-ordering the predetermined sequence order in accordance with the probability determination.

11. The method of claim 1 comprising filtering the received physiological data;
wherein the correlating comprises correlating the filtered physiological data with the program state data, each of the filtered physiological data and the program state data associated with the predetermined time interval; the emotional response type determining comprising determining the emotional response type corresponding to the filtered physiological data by comparing the filtered physiological data with the at least one physiological data profile associated with the predetermined emotional response type.

12. The method of claim 1 wherein the program state data is received from a second computing device in communication with the computing device; the indication providing comprising transmitting the modified state data to the second computing device for indication to the user.

13. The method of claim 1 wherein the indication providing comprises providing an indication associated with the modified program state data to the user at the computing device.

14. A method, performed by a computing device in communication with at least one sensor and a computer server, comprising:
the computing device receiving physiological data from the at least one sensor, the physiological data representative of a user emotional response measured by the at least one sensor;
the computing device transmitting the received physiological data and program state data to the computer server;
the computer server correlating the received physiological data with the program state data, each of the received physiological data and the program state data associated with a predetermined time interval;
the computer server determining an emotional response type corresponding to the received physiological data by comparing the received physiological data with at least one physiological data profile associated with a predetermined emotional response type;
the computer server transmitting modified program state data to the computing device, the modified program state data based at least partly on the program state data and the determined emotional response type; and
the computing device providing an indication associated with modified program state data.

15. The method of claim 14 comprising the computer server updating the at least one physiological data profile based at least partly on the received physiological data and program state data.

16. The method of claim 15 wherein the at least one physiological data profile is associated with at least one user.

17. The method claim 16 wherein each physiological data profile associated with any user is updated with received physiological data associated with any other user correlated to the same program state data.

18. A method, performed by a computing device in communication with at least one sensor and a computer server, comprising:
the computing device receiving physiological data from the at least one sensor, the physiological data representative of a user emotional response measured by the at least one sensor;
the computing device correlating the received physiological data with the program state data, each of the received physiological data and the program state data associated with a predetermined time interval;
the computing device updating at least one physiological data profile associated with a predetermined emotional response type with updated physiological data received from the computer server;
the computing device determining an emotional response type corresponding to the received physiological data by comparing the received physiological data with the received at least one physiological data profile; and
the computing device providing an indication associated with modified program state data, the modified program state data based at least partly on the program state data and the determined emotional response type.

19. The method of claim 18 comprising:
the computing device transmitting the received physiological data and program state data to the computer server;
the computer server updating a server physiological data profile with the received physiological data and program state data, the server physiological data profile comprising updated physiological data associated with the program state data.

20. The method of claim 18 wherein the determined emotional response type is one of frustration, anxiety, and anger.

21. The method of claim 18 wherein the program state data comprises a first indicated question having an associated first difficulty level; the modified program state comprising a second question having an associated second difficulty level, lesser than the first indicated question difficulty level.

22. A computer system for adapting digital content comprising:
(a) one or more computers, implementing a content adapting utility, the content adapting utility when executed:
receives physiological data from at least one sensor, the physiological data representative of a user emotional response measured by the at least one sensor;
correlates the received physiological data with program state data, each of the received physiological data and the program state data associated with a predetermined time interval;
determines an emotional response type corresponding to the received physiological data by comparing the received physiological data with at least one physiological data profile associated with a predetermined emotional response type; and
provides an indication associated with modified program state data, the modified program state data based at least partly on the program state data and the determined emotional response type.

23. The computer system of claim 22 wherein the program state data comprises a program state data value corresponding to a respective user input at the second computing device.

24. The computer system of claim 23, wherein the content adapting utility when executed:
determines a probability of receiving a subsequent program state data value, the determined probability based at least partly on the determined emotional response type and the received program state data;
wherein the modified program state data is based at least partly on the determined probability.

25. The computer system of claim 23, wherein the content adapting utility when executed:
determines a probability of receiving subsequent physiological data corresponding to a subsequent emotional response type, the determined probability based at least partly on the determined emotional response type and the received program state data;
wherein the modified program state data is based at least partly on the determined probability.

26. The computer system of claim 24, wherein the content adapting utility when executed:
determines a second probability of receiving the subsequent program state data value, the determined second probability based at least partly on the determined emotional response type, the received program state data, and a selected predetermined program state data value associated with the determined emotional response type and the received program state data; and
in accordance with a comparison of the determined second probability to the determined probability, updates the modified program state data in accordance with the selected predetermined program state data value.

27. The computer system of claim 25, wherein the content adapting utility when executed:
determines a second probability of receiving the subsequent physiological data corresponding to the subsequent emotional response type, the determined second probability based at least partly on the determined emotional response type, the received program state data, and a selected predetermined program state data value associated with the determined emotional response type and the received program state data;
in accordance with a comparison of the determined second probability to the determined probability, updates the modified program state data in accordance with the selected predetermined program state data value.

28. A computer system for adapting digital content comprising:
(a) one or more computers, including or linked to a device for communication content (“content device”) to one or more users, and implementing a content adapting utility for adapting content generated by one or more computer programs associated with the one or more computers, wherein the one or more computer programs include a plurality of rules for communicating content to one or more users using the content device, wherein the content adapting utility when executed:
receives physiological data from at least one sensor, the physiological data representative of a user emotional response measured by the at least one sensor;
correlates the received physiological data with program state data, each of the received physiological data and the program state data associated with a predetermined time interval;
determines an emotional response type corresponding to the received physiological data by comparing the received physiological data with one or more parameters associated with a predetermined emotional response type, including one or more of the rules for communication content; and
adapting digital content displayed to the one or more users based on user emotion response by executing the one or more rules for displaying content that correspond to the relevant emotional response type.

29. The computer system of claim 28 wherein the program state data comprises a program state data value corresponding to a respective user input at the second computing device.

30. The computer system of claim 29, wherein the content adapting utility when executed:
determines a probability of receiving a subsequent program state data value, the determined probability based at least partly on the determined emotional response type and the received program state data;
wherein the modified program state data is based at least partly on the determined probability.

31. The computer system of claim 29, wherein the content adapting utility when executed:
determines a probability of receiving subsequent physiological data corresponding to a subsequent emotional response type, the determined probability based at least partly on the determined emotional response type and the received program state data;
wherein the modified program state data is based at least partly on the determined probability.

32. The computer system of claim 30, wherein the content adapting utility when executed:
determines a second probability of receiving the subsequent program state data value, the determined second probability based at least partly on the determined emotional response type, the received program state data, and a selected predetermined program state data value associated with the determined emotional response type and the received program state data; and
in accordance with a comparison of the determined second probability to the determined probability, updates the modified program state data in accordance with the selected predetermined program state data value.

33. The computer system of claim 31, wherein the content adapting utility when executed:
determines a second probability of receiving the subsequent physiological data corresponding to the subsequent emotional response type, the determined second probability based at least partly on the determined emotional response type, the received program state data, and a selected predetermined program state data value associated with the determined emotional response type and the received program state data;
in accordance with a comparison of the determined second probability to the determined probability, updates the modified program state data in accordance with the selected predetermined program state data value.
